(19) United States
(12) Patent Application Publication
(10) Pub. No.: US 2026/0265883 A1
(43) Pub. Date: Sep. 10, 2026

(54) STEEL SHEET

(71) Applicant: NIPPON STEEL CORPORATION, Tokyo (JP)

(72) Inventors: Koyo OHGA, Tokyo (JP); Kengo TAKEDA, Tokyo (JP); Satoshi HIRONAKA, Tokyo (JP)

(73) Assignee: NIPPON STEEL CORPORATION, Tokyo (JP)

(21) Appl. No.: 18/873,269

(22) PCT Filed: Apr. 26, 2023
(86) PCT No.: PCT/JP2023/016439

§ 371 Date: Dec. 9, 2024

(30) Foreign Application Priority Data
Aug. 3, 2022 (JP) 2022-124212

(51) Int. Cl. C22C 38/04; B22D 11/00; B32B 15/01; C21D 1/74; C21D 6/00; C21D 8/021; C21D 8/0221; C21D 8/0247; C21D 9/46; C22C 38/00; C22C 38/02; C22C 38/06; C22C 38/08; C22C 38/10; C22C 38/12; C22C 38/14; C22C 38/16; C22C 38/22; C22C 38/30; C22C 38/32; C22C 38/34; C22C 38/38; C22C 38/60

(52) U.S. Cl. CPC C22C 38/04; B22D 11/001; B32B 15/013; C21D 1/74; C21D 6/001; C21D 6/002; C21D 6/005; C21D 6/007; C21D 6/008; C21D 8/021; C21D 8/0226; C21D 8/0236; C21D 8/0257; C21D 9/46; C22C 38/001; C22C 38/002; C22C 38/005; C22C 38/008; C22C 38/02; C22C 38/06; C22C 38/08; C22C 38/10; C22C 38/12; C22C 38/14; C22C 38/16; C22C 38/22; C22C 38/30; C22C 38/32; C22C 38/34; C22C 38/38; C22C 38/60; C21D 2211/005; C21D 2211/008

(57) ABSTRACT

Provided is a steel sheet having a predetermined chemical composition, wherein an average Vickers hardness Hs in a region from at least one surface down to 10% of sheet thickness is 0.60 time or less an average Vickers hardness Hc at a ½ position of sheet thickness, a ratio of macro brittle fracture surface in a Charpy impact test at room temperature is 35.0% or less, and a tensile strength is 1500 MPa or more.

### FIELD

The present invention relates to a steel sheet.

### BACKGROUND

In recent years, in the automobile industry, reduction of the weight of car bodies has been sought from the viewpoint of improvement of the fuel efficiency. To achieve both lighter weight of car bodies and collision safety, raising the strength of the steel sheet used is one effective method. Due to such background, development of a high strength steel sheet has been proceeding.

In the high strength steel sheet, sometimes hydrogen embrittlement cracking (also referred to as “delayed fracture”, etc.) becomes a problem. “Hydrogen embrittlement cracking” is the phenomenon of a steel member on which high stress acts in a usage environment suddenly fracturing due to hydrogen penetrating the steel from the environment.

In relation to this, PTL 1 describes a high-strength hot-dip galvanized steel sheet having a chemical composition comprising, in mass %, C: 0.08 to 0.35%, Si: 0.01 to 3.0%, Mn: 2.0 to 4.0%, P: 0.010% or less (excluding 0), S: 0.002% or less (excluding 0), Al: 0.01 to 1.50%, and B: 0.0005 to 0.010% and further comprising one or more selected from Mo: 0.03 to 2.0% and Ti: 0.010 to 0.10%, with the balance being Fe and unavoidable impurities, wherein the steel sheet has a steel microstructure in which, in a region extending from 300 to 400 μm from a surface layer of the steel sheet in a thickness direction of the steel sheet, the total area fraction of martensite and bainite containing carbides is 60 to 100%, and the average grain size of prior austenite is 15 μm or less, and in which, in the region extending from 300 to 400 μm from the surface layer of the steel sheet in the thickness direction of the steel sheet, the ratio of the height of a peak of P in an Auger electron spectrum at a position 5 nm or more from a prior-austenite grain boundary to the height of a peak of P in an Auger electron spectrum at the prior-austenite grain boundary is 0.20 or more, and wherein the steel sheet has a hot-dip galvanized layer on a surface thereof. Further, PTL 1 teaches that according to the above constitution, segregation of P at the prior-austenite grain boundaries is reduced, and a high-strength galvanized steel sheet excellent in delayed fracture resistance can be obtained.

PTL 2 describes a high-strength hot-dip galvanized steel sheet, comprising: a hot-dip galvanized layer on a surface of the steel sheet; a component composition containing, on a percent by mass basis: C: 0.12% to 0.35%, Si: 0.01% to 3.0%, Mn: 2.0% to 4.0%, P: 0.100% or less (excluding 0), S: 0.02% or less (excluding 0), and Al: 0.01% to 1.50%, the balance being Fe and incidental impurities; and a steel microstructure containing, on an area percentage basis, 0% to 15% of ferrite and upper bainite in total, 80% to 100% of lower bainite and martensite in total, and 0% to 10% of retained austenite, and containing precipitates having a particle size of 100 to 2,000 nm in terms of equivalent circular diameter in an amount of 10⁹ to 10¹² particles/m² in a region extending from a surface layer of the steel sheet to a position 100 to 300 μm from the surface layer of the steel sheet in a thickness direction, wherein a ratio of an average amount of C at a position 5 μm from the surface layer of the steel sheet in the thickness direction to an average amount of C at a position 70 μm from the surface layer of the steel sheet in the thickness direction is 0.20 to 0.80. Further, PTL 2 teaches that by controlling the ratio of an average amount of C at a position 5 μm from the surface layer of the steel sheet in the thickness direction to an average amount of C at a position 70 μm from the surface layer of the steel sheet in the thickness direction to 0.20 to 0.80, the stress near the surface layer is relieved to obtain excellent delayed fracture resistance.

PTL 3 describes an ultra high strength cold rolled steel sheet with excellent bendability which comprises, in terms of mass %, C at 0.15 to 0.30%, Si at 0.01 to 1.8%, Mn at 1.5 to 3.0%, P at not more than 0.05%, S at not more than 0.005%, Al at 0.005 to 0.05% and N at not more than 0.005%, with the balance being represented by Fe and inevitable impurities, and has a steel sheet superficial soft portion satisfying Equation (1): Hv(S)/Hv (C)≤0.8 wherein Hv(S) is the hardness of the steel sheet superficial soft portion, and Hv (C) is the hardness of a steel sheet core portion, and Equation (2): 0.10≤t(S)/t≤0.30 wherein t(S) is the thickness of the steel sheet superficial soft portion, and t is the sheet thickness, the steel sheet superficial soft portion containing tempered-martensite at a volume fraction of not less than 90%, the microstructure of the steel sheet core portion including tempered-martensite, the ultra high strength cold rolled steel sheet having a tensile strength of not less than 1270 MPa. Further, PTL 3 teaches that by satisfying the above (1) and (2), there is the effect of improvement of the bendability and delayed fracture resistance.

PTL 4 describes a high strength cold rolled steel sheet containing, by wt %, C: 0.05 to 0.20%, P: 0.001 to 0.030%, S: 0.001 to 0.050%, Al: 0.001 to 0.100%, and N: 0.0002 to 0.0050% in ranges, containing one or more of Si: 0.10 to 2.50%, Mn: 0.5 to 3.50%, Cr: 0.10 to 1.5%, Mo: 0.10 to 1.5%, and B: 0.001 to 0.005%, and having a balance of Fe and unavoidable impurities, wherein surface layer parts of parts of 0.010 to 0.20 mm per surface from the front and rear surfaces of the steel sheet are comprised mainly of ferrite, and the inside layer part is comprised mainly of bainite and martensite. Further, PTL 4 teaches that according to the above constitution, it is possible to provide a steel sheet excellent in workability and delayed fracture resistance since the surface layers of the steel sheet have layers mainly comprised of ferrite and the inside layer has a layer mainly comprised of martensite and bainite.

### CITATIONS LIST

### Patent Literature

[PTL 1] WO 2020/136990
[PTL 2] WO 2020/136988
[PTL 3] Japanese Unexamined Patent Publication No. 2011-179030
[PTL 4] Japanese Unexamined Patent Publication No. 10-130782

### SUMMARY

### Technical Problem

In general, it is known that hydrogen embrittlement cracking more easily occurs the higher the strength of a steel material. It occurs particularly easily at bent parts at which large plastic strain is given. On the other hand, in the automobile industry, etc., lighter weight of the steel materials is also being sought. To achieve such lighter weight, a need arises for making the steel material higher in strength than before. Therefore, there is a high need for a steel material able to solve the problem of hydrogen embrittlement even when making the strength a high one equal to or greater than in the past, more specifically a high strength steel sheet excellent in hydrogen embrittlement resistance of the bent parts.

Therefore, the present invention has as its object to provide a steel sheet high in strength and excellent in hydrogen embrittlement resistance of bent parts by a novel constitution.

### Solution to Problem

The inventors engaged in studies to achieve this object and as a result discovered that in a high strength steel sheet having a tensile strength of 1500 MPa or more, by simultaneously reducing grain boundary segregation of elements causing embrittlement of the grain boundary so as to control the ratio of macro brittle fracture surface in a Charpy impact test to within a predetermined range and softening the surface layer parts of a steel sheet to increase the upper limit of the amount of hydrogen not causing hydrogen embrittlement at bent parts, i.e., the critical hydrogen content, it is possible to remarkably improve the hydrogen embrittlement resistance of bent parts even in a steel sheet having an extremely high tensile strength of 1500 MPa or more and thereby completed the present invention.

The present invention able to achieve the above object is as follows:

(1) A steel sheet having a chemical composition comprising, by mass %,
C: 0.15 to 0.40%,
Si: 0.01 to 2.00%,
Mn: 0.80 to 3.50%,
P: 0.0001 to 0.0200%,
S: 0.0001 to 0.0200%,
Al: 0.001 to 1.000%,
N: 0.0001 to 0.020%,
O: 0.0001 to 0.0200%,
Co: 0 to 0.5000%,
Ni: 0 to 1.000%,
Mo: 0 to 1.000%,
Cr: 0 to 2.000%,
Ti: 0 to 0.500%,
B: 0 to 0.0100%,
Nb: 0 to 0.500%,
V: 0 to 0.500%,
Cu: 0 to 0.500%,
W: 0 to 0.100%,
Ta: 0 to 0.100%,
Sn: 0 to 0.100%,
Sb: 0 to 0.100%,
As: 0 to 0.100%,
Mg: 0 to 0.0500%,
Ca: 0 to 0.050%,
Y: 0 to 0.050%,
Zr: 0 to 0.050%,
La: 0 to 0.050%,
Ce: 0 to 0.050%, and
balance: Fe and impurities, wherein
an average Vickers hardness Hs in a region from at least one surface down to 10% of sheet thickness is 0.95 time or less an average Vickers hardness Hc at a ½ position of sheet thickness,
a ratio of macro brittle fracture surface in a Charpy impact test at room temperature is 35.0% or less, and
a tensile strength is 1500 MPa or more.

(2) The steel sheet according to the above (1), wherein the chemical composition includes by mass %, one or more selected from the group consisting of
Co: 0.0100 to 0.5000%,
Ni: 0.010 to 1.000%,
Mo: 0.010 to 1.000%,
Cr: 0.001 to 2.000%,
Ti: 0.001 to 0.500%,
B: 0.0001 to 0.0100%,
Nb: 0.001 to 0.500%,
V: 0.001 to 0.500%,
Cu: 0.001 to 0.500%,
W: 0.001 to 0.100%,
Ta: 0.001 to 0.100%,
Sn: 0.001 to 0.100%,
Sb: 0.001 to 0.100%,
As: 0.001 to 0.100%,
Mg: 0.0001 to 0.0500%,
Ca: 0.001 to 0.050%,
Y: 0.001 to 0.050%,
Zr: 0.001 to 0.050%,
La: 0.001 to 0.050%, and
Ce: 0.001 to 0.050%.

(3) The steel sheet according to the above (1) or (2), having a microstructure at a ½ position of sheet thickness comprising, by area ratio,
martensite and tempered martensite: more than 93.0% in total, and
ferrite: less than 7.0%.

(4) The steel sheet according to any one of the above (1) to (3), wherein an average carbon concentration Cs at a region from at least one surface to 10% of sheet thickness is 0.10 to 0.90 time an average carbon concentration Cc of a parent material.

(5) The steel sheet according to any one of the above (1) to (4), wherein an amount of segregation of P at prior austenite grain boundaries from a ⅛ position of sheet thickness to ½ position of sheet thickness is 3.50 atm % or less.

(6) The steel sheet according to any one of the above (1) to (5), further including a coated layer containing at least one selected from the group consisting of zinc, aluminum, magnesium, and alloys thereof on at least one surface.

### Advantageous Effects of Invention

According to the present invention, it is possible to provide a steel sheet high in strength and excellent in hydrogen embrittlement resistance of bent parts.

### DESCRIPTION OF EMBODIMENTS

The steel sheet according to the embodiments of the present invention is characterized by having a chemical composition comprising, by mass %,
C: 0.15 to 0.40%,
Si: 0.01 to 2.00%,
Mn: 0.80 to 3.50%,
P: 0.0001 to 0.0200%,
S: 0.0001 to 0.0200%,
Al: 0.001 to 1.000%,
N: 0.0001 to 0.020%,
O: 0.0001 to 0.0200%,
Co: 0 to 0.5000%,
Ni: 0 to 1.000%,
Mo: 0 to 1.000%,
Cr: 0 to 2.000%,
Ti: 0 to 0.500%,
B: 0 to 0.0100%,
Nb: 0 to 0.500%,
V: 0 to 0.500%,
Cu: 0 to 0.500%,
W: 0 to 0.100%,
Ta: 0 to 0.100%,
Sn: 0 to 0.100%,
Sb: 0 to 0.100%,
As: 0 to 0.100%,
Mg: 0 to 0.0500%,
Ca: 0 to 0.050%,
Y: 0 to 0.050%,
Zr: 0 to 0.050%,
La: 0 to 0.050%,
Ce: 0 to 0.050%, and
balance: Fe and impurities, wherein
an average Vickers hardness Hs in a region from at least one surface down to 10% of sheet thickness is 0.95 time or less an average Vickers hardness Hc at a ½ position of sheet thickness,
a ratio of macro brittle fracture surface in a Charpy impact test at room temperature is 35.0% or less, and
a tensile strength is 1500 MPa or more.

As explained previously, it is known that hydrogen embrittlement cracking more easily occurs the higher the strength of a steel material. In particular, in a steel sheet having an extremely high strength such as a tensile strength of 1500 MPa or more, to secure the high strength, the microstructure of the steel sheet generally becomes one mainly containing martensite. On the other hand, in the case of such a high strength steel sheet mainly comprised of martensite, hydrogen embrittlement cracking is believed to occur due to the hydrogen penetrating the steel mainly collecting at the prior austenite grain boundaries in the martensite structures causing the bond strength of the grain boundaries to fall and such grain boundaries with fallen bond strength becoming starting points of embrittlement. In general, along with the rise in tensile strength, the more hydrogen embrittlement occurs even with a small amount of hydrogen. Further, penetration of hydrogen into the steel can occur even at room temperature. Here, there is either no method existing for completely suppressing the penetration of hydrogen into the steel or it is extremely difficult to completely suppress it. For this reason, to fundamentally solve the problem of hydrogen embrittlement in a high strength steel sheet having a tensile strength of 1500 MPa or more, it is important to improve the microstructure of bent parts where hydrogen embrittlement easily occurs due to particularly large plastic strain imparted.

Therefore, the inventors engaged in studies to improve the hydrogen embrittlement resistance in a steel sheet having an extremely high strength such as a tensile strength of 1500 MPa or more, in particular at the bent parts. As a result, the inventors discovered that it is effective to suppress embrittlement of prior austenite grain boundaries which become starting points for hydrogen embrittlement cracking in the microstructure and to increase the upper limit of the amount of hydrogen not causing hydrogen embrittlement at bent parts, i.e., the critical hydrogen content. More specifically, the inventors discovered that it is possible to remarkably improve the hydrogen embrittlement resistance of bent parts even in a steel sheet having an extremely high tensile strength of 1500 MPa or more by lowering the grain boundary segregation of P and other elements causing embrittlement of grain boundaries so as to control the ratio of macro brittle fracture surface at a Charpy impact test at room temperature to 35.0% or less and softening the surface layer parts for increasing the critical hydrogen content of the steel sheet surface layer parts where hydrogen embrittlement easily occurs at the time of bending, in more detail, controlling the average Vickers hardness Hs at the region from at least one surface of the steel sheet down to 10% of the sheet thickness to 0.95 time or less the average Vickers hardness Hc at the ½ position of sheet thickness.

Even by, for example, just softening the steel sheet surface layer parts where hydrogen embrittlement easily occurs at the time of bending, it is possible to improve the hydrogen embrittlement resistance of the bent parts. However, to obtain sufficient hydrogen embrittlement resistance in the case of a steel sheet having an extremely high strength such as a tensile strength of 1500 MPa or more, a need arises for making the degree of softening of the surface layer parts extremely high. However, in such a case, while the hydrogen embrittlement resistance is improved, conversely it is difficult to maintain a sufficient tensile strength, i.e., a tensile strength of 1500 MPa or more. Similarly, by lowering the grain boundary segregation of specific elements causing embrittlement of grain boundaries, it is possible to improve the hydrogen embrittlement resistance. However, in the case of a steel sheet having an extremely high strength such as a tensile strength of 1500 MPa or more, by just lowering the grain boundary segregation of specific elements, it is difficult to reliably improve the hydrogen embrittlement resistance of bent parts to the desired level. Therefore, in the steel sheet according to embodiments of the present invention, to reliably maintain a tensile strength of 1500 MPa or more while on the other hand achieve the desired hydrogen embrittlement resistance at the bent parts, it is extremely important to simultaneously control the ratio of the macro brittle fracture surface at a Charpy impact test to 35.0% or less and control the average Vickers hardness Hs in a region from at least one surface of the steel sheet down to 10% of the sheet thickness to 0.95 time or less the average Vickers hardness Hc at the ½ position of sheet thickness. According to the present invention, by a specific combination of these technical matters, despite being a steel sheet having an extremely high strength of 1500 MPa or more, it is possible to reliably and remarkably improve the hydrogen embrittlement resistance of the bent parts. Therefore, according to the present invention, for example, even in applications such as automobiles where contradictory properties of excellent bendability and high strength are demanded, it is possible to achieve both of these properties while achieving excellent hydrogen embrittlement resistance at the bent parts.

Below, the steel sheet according to embodiments of the present invention will be explained in more detail. In the following explanation, the units “%” of content of the elements, unless otherwise indicated, mean “mass %”. Further, in this Description, the “to” indicating a numerical range, unless otherwise indicated, means including the numerical values described before and after it as a lower limit value and upper limit value.

### [C: 0.15 to 0.40%]

C is an element effective for inexpensively making the tensile strength increase. To sufficiently obtain such an effect, the C content is 0.15% or more. The C content may also be 0.16% or more, 0.18% or more, 0.20% or more, more than 0.20%, 0.21% or more, 0.22% or more, or 0.23% or more.

On the other hand, if excessively containing C, sometimes coarse grain boundary carbides are formed. The grain boundaries easily become brittle. In addition, microscopic cracks are introduced, etc., and therefore the hydrogen embrittlement resistance falls. Sometimes the weldability falls. For this reason, the C content is 0.40% or less. The C content may also be 0.38% or less, 0.35% or less, 0.30% or less, or 0.25% or less.

### [Si: 0.01 to 2.00%]

Si is an element acting as a deoxidizer and having an effect on the form of the carbides and retained austenite after heat treatment. If not containing Si, sometimes it is difficult to suppress the formation of coarse oxides. Such coarse oxides become the starting points of cracks and sometimes the cracks propagate inside the steel material whereby the hydrogen embrittlement resistance deteriorates. For this reason, the Si content is 0.01% or more. The Si content may also be 0.05% or more, 0.10% or more, 0.30% or more, or 0.50% or more.

On the other hand, if excessively containing Si, sometimes the local ductility falls and the hydrogen embrittlement resistance deteriorates. For this reason, the Si content is 2.00% or less. The Si content may also be 1.80% or less, 1.60% or less, 1.40% or less, or 1.20% or less.

### [Mn: 0.80 to 3.50%]

Mn is an element effective for enhancing the hardenability of steel to raise the strength of the steel sheet. To sufficiently obtain such an effect, the Mn content is 0.80% or more. The Mn content may also be 1.00% or more, 1.20% or more, 1.40% or more, or 1.60% or more.

On the other hand, if excessively containing Mn, the Mn not only aggravates cosegregation with P and S, but also sometimes causes deterioration of the corrosion resistance and hydrogen embrittlement resistance. For this reason, the Mn content is 3.50% or less. The Mn content may also be 3.40% or less, 3.30% or less, 3.20% or less, 3.10% or less, 3.00% or less, 2.90% or less, 2.80% or less, less than 2.60%, 2.55% or less, 2.50% or less, less than 2.50%, 2.45% or less, 2.40% or less, 2.20% or less, or 2.00% or less.

### [P: 0.0001 to 0.0200%]

P is an element segregating at the prior austenite grain boundaries and promoting embrittlement of the grain boundaries. If excessively containing P, grain boundary embrittlement causes the hydrogen embrittlement resistance to remarkably drop. For this reason, the P content is 0.0200% or less. The P content may also be 0.0180% or less, 0.0150% or less, 0.0120% or less, or 0.0100% or less.

From the viewpoint of improvement of the hydrogen embrittlement resistance, the smaller the P content, the better. However, to lower the P content to less than 0.0001%, a lot of time is required for refining and a large increase in cost is invited. For this reason, the P content is 0.0001% or more. The P content may also be 0.0005% or more, 0.0010% or more, or 0.0020% or more.

### [S: 0.0001 to 0.0200%]

S is an element forming MnS and other nonmetallic inclusions in steel. If excessively containing S, formation of nonmetallic inclusions becoming starting points for cracks at the time of cold working becomes remarkable. In this case, by cracks forming from the nonmetallic inclusions and these cracks being propagated through the inside of the steel material, sometimes the hydrogen embrittlement resistance deteriorates. For this reason, the S content is 0.0200% or less. The S content may also be 0.0180% or less, 0.0150% or less, 0.0120% or less, or 0.0100% or less.

From the viewpoint of improvement of the hydrogen embrittlement resistance, the smaller the S content, the better. However, to reduce the S content to less than 0.0001%, a lot of time is required for refining and a large increase in cost is invited. For this reason, the S content is 0.0001% or more. The S content may also be 0.0005% or more, 0.0010% or more, or 0.0020% or more.

### [Al: 0.001 to 1.000%]

Al is an element acting as a deoxidizer of steel and stabilizing ferrite. To sufficiently obtain such an effect, the Al content is 0.001% or more. The Al content may also be 0.005% or more, 0.010% or more, 0.020% or more, or 0.050% or more.

On the other hand, if excessively containing Al, coarse Al oxides are formed and sometimes become starting points of cracks. Further, these cracks propagate through the inside of the steel material whereby sometimes the hydrogen embrittlement resistance deteriorates. For this reason, the Al content is 1.000% or less. The Al content may also be 0.950% or less, 0.900% or less, 0.800% or less, or 0.600% or less.

### [N: 0.0001 to 0.020%]

N is an element forming coarse nitrides in the steel sheet and lowering the hydrogen embrittlement resistance of the steel sheet. Further, N is an element becoming the cause of formation of blowholes at the time of welding. Therefore, the smaller the N content, the better. It is 0.020% or less. The N content may also be 0.018% or less, 0.016% or less, 0.012% or less, or 0.010% or less.

On the other hand, to reduce the N to less than 0.0001%, a large increase in production cost is invited. For this reason, the N content is 0.0001% or more. The N content may also be 0.0005% or more, 0.001% or more, or 0.002% or more.

### [O: 0.0001 to 0.0200%]

O is an element forming oxides and causing deterioration of the hydrogen embrittlement resistance. In particular, oxides are often present as inclusions. If they are present om punched end faces or cut faces, the end faces are formed with notch-like scratches or coarse dimples, and therefore at the time of strong working, stress concentration is invited and become starting points of crack formation and sometimes a great deterioration in workability is caused. If excessively containing O, the trend toward deterioration of the hydrogen embrittlement resistance and workability becomes remarkable. For this reason, the O content is 0.0200% or less. The O content may also be 0.0180% or less, 0.0150% or less, 0.0120% or less, or 0.0100% or less.

The smaller the O content, the better. However, to reduce the O to less than 0.0001%, a large increase in production cost is invited. For this reason, the O content is 0.0001% or more. The O content may also be 0.0005% or more, 0.0010% or more, or 0.0015% or more.

The basic chemical composition of the steel sheet according to the embodiments of the present invention is as explained above. Furthermore, the steel sheet may also contain at least one of the following optional elements in place of part of the Fe of the balance in accordance with need. For example, the steel sheet may also contain at least one selected from the group consisting of Co: 0 to 0.5000%, Ni: 0 to 1.000%, Mo: 0 to 1.000%, Cr: 0 to 2.000%, Ti: 0 to 0.500%, B: 0 to 0.0100%, Nb: 0 to 0.500%, V: 0 to 0.500%, Cu: 0 to 0.500%, W: 0 to 0.100%, and Ta: 0 to 0.100%. Further, the steel sheet may contain at least one selected from the group consisting of Sn: 0 to 0.100%, Sb: 0 to 0.100%, and As: 0 to 0.100%. Further, the steel sheet may contain at least one selected from the group consisting of Mg: 0 to 0.0500%, Ca: 0 to 0.050%, Y: 0 to 0.050%, Zr: 0 to 0.050%, La: 0 to 0.050%, and Ce: 0 to 0.050%. Below, these optional elements will be explained in detail.

### [Co: 0 to 0.5000%]

Co is an element effective for controlling the form of carbides and increasing the strength of the steel sheet. The Co content may also be 0%, but to obtain these effects, the Co content is preferably 0.0010% or more. The Co content may also be 0.0100% or more, 0.0200% or more, 0.0500% or more, or 0.1000% or more.

On the other hand, if excessively containing Co, coarse Co carbides precipitate and sometimes the hydrogen embrittlement resistance deteriorates. For this reason, the Co content is 0.5000% or less. The Co content may also be 0.4000% or less, 0.3000% or less, or 0.2000% or less.

### [Ni: 0 to 1.000%]

Ni is an element effective for raising the strength of the steel sheet. Further, Ni is an element effective for improving the wettability and promoting an alloying reaction. The Ni content may be 0% as well, but to obtain these effects, the Ni content is preferably 0.001% or more. The Ni content may also be 0.010% or more, 0.020% or more, 0.050% or more, or 0.100% or more.

On the other hand, if excessively containing Ni, sometimes the hydrogen embrittlement resistance falls. For this reason, Ni content is 1.000% or less. The Ni content may also be 0.900% or less, 0.800% or less, 0.600% or less, or 0.300% or less.

### [Mo: 0 to 1.000%]

Mo is an element effective for raising the strength of the steel sheet. Further, Mo is an element having the effect of suppressing ferrite transformation occurring at the time of heat treatment in a continuous annealing facility or continuous hot dip galvanization facility. The Mo content may be 0% as well, but to obtain these effects, the Mo content is preferably 0.001% or more. The Mo content may also 0.010% or more, 0.020% or more, 0.050% or more, or 0.080% or more.

On the other hand, even if Mo is excessively contained, the effect of suppression of ferrite transformation becomes saturated or coarse intermetallic compounds and carbides are formed and the hydrogen embrittlement resistance sometimes falls. For this reason, the Mo content is 1.000% or less. The Mo content may also be 0.900% or less, 0.800% or less, 0.600% or less, or 0.300% or less.

### [Cr: 0 to 2.000%]

Cr is an element suppressing pearlite transformation and effective for increasing the strength of steel. The Cr content may also be 0%, but to obtain such an effect, the Cr content is preferably 0.001% or more. The Cr content may be 0.005% or more, 0.010% or more, 0.020% or more, or 0.050% or more.

On the other hand, if excessively containing Cr, coarse Cr carbides are formed at the center segregated part and sometimes the hydrogen embrittlement resistance falls. For this reason, the Cr content is 2.000% or less. The Cr content may also be 1.800% or less, 1.500% or less, 1.000% or less, or 0.500% or less.

### [Ti: 0 to 0.500%]

Ti is an element contributing to the rise of strength of the steel sheet by precipitation strengthening, fine grain strengthening by suppression of growth of ferrite crystal grains, and dislocation strengthening through suppression of recrystallization. The Ti content may also be 0%, but to obtain these effects, the Ti content is preferably 0.001% or more. The Ti content may also be 0.005% or more, 0.010% or more, or 0.050% or more.

On the other hand, if excessively containing Ti, the amount of precipitation of carbides becomes greater and sometimes the hydrogen embrittlement resistance deteriorates. For this reason, the Ti content is 0.500% or less. The Ti content may also be 0.450% or less, 0.400% or less, 0.300% or less, or 0.100% or less.

### [B: 0 to 0.0100%]

B is an element promoting the suppressing the formation of ferrite and pearlite and promoting the formation of bainite or martensite or other low temperature transformed structures in the process of cooling from the austenite temperature region. Further, B is an element beneficial for raising the strength of steel. The B content may also be 0%, but to obtain these effects, the B content is preferably 0.0001% or more. The B content may also be 0.0003% or more, 0.0005% or more, or 0.0010% or more.

On the other hand, if excessively containing B, sometimes coarse B oxides are formed in the steel. These oxides become starting points of formation of voids at the time of cold working, and therefore sometimes the formation of coarse B oxides causes the hydrogen embrittlement resistance to deteriorate. For this reason, the B content is 0.0100% or less. The B content may also be 0.0080% or less, 0.0060% or less, 0.0050% or less, or 0.0020% or less.

### [Nb: 0 to 0.500%]

Nb is an element effective for control of the form of carbides and an element also effective for improvement of the toughness due to refinement of the microstructure. The Nb content may also be 0%, but to obtain these effects, the Nb content is preferably 0.001% or more. The Nb content may also be 0.002% or more, 0.010% or more, or 0.020% or more.

On the other hand, if excessively containing Nb, sometimes coarse Nb carbides are formed. These coarse Nb causes easily cause cracks and sometimes cause deterioration of the hydrogen embrittlement resistance. For this reason, the Nb content is 0.500% or less. The Nb content may also be 0.450% or less, 0.400% or less, 0.300% or less, or 0.100% or less.

### [V: 0 to 0.500%]

V is an element contributing to the rise of strength of the steel sheet by precipitation strengthening, fine grain strengthening by suppression of growth of ferrite crystal grains, and dislocation strengthening through suppression of recrystallization. The V content may also be 0%, but to obtain these effects, the V content is preferably 0.001% or more. The V content may also be 0.002% or more, 0.010% or more, or 0.020% or more.

On the other hand, if excessively containing V, the amount of precipitation of carbides becomes greater and sometimes the hydrogen embrittlement resistance deteriorates. For this reason, the V content is 0.500% or less. The V content may also be 0.450% or less, 0.400% or less, 0.300% or less, or 0.100% or less.

### [Cu: 0 to 0.500%]

Cu is an element effective for improving the strength of the steel sheet. The Cu content may be 0% as well, but to obtain such an effect, the Cu content is preferably 0.001% or more. The Cu content may also be 0.002% or more, 0.010% or more, or 0.030% or more.

On the other hand, if excessively containing Cu, sometimes the hydrogen embrittlement resistance deteriorates. Further, if the Cu content is great, during hot rolling, sometimes the steel material becomes brittle and hot rolling becomes difficult. For this reason, the Cu content is 0.500% or less. The Cu content may also be 0.450% or less, 0.400% or less, 0.300% or less, or 0.100% or less.

### [W: 0 to 0.100%]

W is an element effective for raising the strength of the steel sheet. Further, W forms precipitates or crystals. The precipitates and crystals containing W become hydrogen trap sites, and therefore W is an element effective for improvement of hydrogen embrittlement resistance. The W content may also be 0%, but to obtain these effects, the W content is preferably 0.001% or more. The W content may also be 0.002% or more, 0.005% or more, or 0.010% or more.

On the other hand, if excessively containing W, coarse W precipitates or crystals are sometimes formed. These coarse W precipitates or crystals easily cause cracks. These cracks are sometimes propagated inside a steel material due to relatively low load stress. For this reason, if coarse coarse W precipitates or crystals are formed, sometimes the hydrogen embrittlement resistance deteriorates. For this reason, the W content is 0.100% or less. The W content may also be 0.080% or less, 0.060% or less, 0.050% or less, or 0.030% or less.

### [Ta: 0 to 0.100%]

Ta is an element effective for control of the form of carbides and increase of strength of the steel sheet. The Ta content may also be 0%, but to obtain these effects, the Ta content is preferably 0.001% or more. The Ta content may also be 0.002% or more, 0.005% or more, or 0.010% or more.

On the other hand, if excessively containing Ta, a large number of fine Ta carbides precipitate and sometimes along with the rise in strength of the steel sheet, the ductility falls or the bending resistance and hydrogen embrittlement resistance fall. For this reason, the Ta content is 0.100% or less. The Ta content may also be 0.080% or less, 0.060% or less, 0.050% or less, or 0.020% or less.

### [Sn: 0 to 0.100%]

Sn is an element contained in steel when using scrap as a steel raw material. If the Sn content is large, sometimes embrittlement of the grain boundaries causes the hydrogen embrittlement resistance to fall. For this reason, the Sn content is 0.100% or less. The Sn content may also be 0.060% or less, 0.030% or less, or 0.020% or less.

The smaller the Sn content, the better. 0% is also possible. However, to reduce the Sn content to less than 0.001%, a lot of time is required for refining and a large increase in cost is invited. For this reason, the Sn content may also be 0.001% or more. The Sn content may also be 0.002% or more, 0.005% or more, or 0.010% or more.

### [Sb: 0 to 0.100%]

Sb, like Sn, is an element contained when using scrap as a steel raw material. Further, Sb is an element strongly segregating at the grain boundaries and inviting embrittlement of the grain boundaries and a drop in ductility. For this reason, the Sb content is 0.100% or less. The Sb content may also be 0.040% or less, 0.030% or less, or 0.020% or less.

The smaller the Sb content, the better. 0% is also possible, but to reduce the Sb content to less than 0.001%, a lot of time is required for refining and a large increase in cost is invited. For this reason, the Sb content may also be 0.001% or more. The Sb content may also be 0.002% or more, 0.005% or more, or 0.008% or more.

### [As: 0 to 0.100%]

As, like Sn and Sb, is an element contained when using scrap as a steel raw material. Further, As is an element strongly segregating at the grain boundaries and inviting embrittlement of the grain boundaries and a drop of ductility. For this reason, the As content is 0.100% or less. The As content may also be 0.040% or less, 0.030% or less, or 0.020% or less.

The smaller the As content, the better. 0% is also possible, but to reduce the As content to less than 0.001%, a lot of time is required for refining and a large increase in cost is invited. For this reason, the As content may be 0.001% or more. The As content may also be 0.002% or more, 0.003% or more, or 0.005% or more.

### [Mg: 0 to 0.0500%]

Mg is an element enabling control of the form of sulfides by inclusion of a trace amount. The Mg content may also be 0%, but to obtain such an effect, the Mg content is preferably 0.0001% or more. The Mg content may also be 0.0005% or more, 0.0010% or more, 0.0015% or more, or 0.0020% or more.

On the other hand, if excessively containing Mg, coarse inclusions are formed and sometimes the hydrogen embrittlement resistance falls. For this reason, the Mg content is 0.0500% or less. The Mg content may also be 0.0300% or less, 0.0100% or less, 0.0050% or less, or 0.0030% or less.

### [Ca: 0 to 0.050%]

Ca is an element useful as a deoxidizer and exhibiting an effect in control of the form of sulfides. The Ca content may also be 0%, but to obtain these effects, the Ca content is preferably 0.0001% or more. The Ca content may also be 0.0005% or more, 0.001% or more, or 0.002% or more.

On the other hand, if excessively containing Ca, coarse inclusions are formed and sometimes the hydrogen embrittlement resistance falls. For this reason, the Ca content is 0.050% or less. The Ca content may also be 0.030% or less, 0.010% or less, 0.005% or less, or 0.003% or less.

### [Y: 0 to 0.050%]

Y is an element able to control the form of sulfides by a trace amount in the same way as Mg, etc. The Y content may also be 0%, but to obtain such an effect, the Y content is preferably 0.0001% or more. The Y content may also be 0.0005% or more, 0.001% or more, or 0.002% or more.

On the other hand, if excessively containing Y, coarse Y oxides are formed and sometimes the hydrogen embrittlement resistance falls. For this reason, the Y content is 0.050% or less. The Y content may also be 0.030% or less, 0.010% or less, 0.005% or less, or 0.003% or less.

### [Zr: 0 to 0.050%]

Zr is an element able to control the form of sulfides by a trace amount in the same way as Mg, etc. The Zr content may also be 0%, but to obtain such an effect, the Zr content is preferably 0.0001% or more. The Zr content may also be 0.0005% or more, 0.001% or more, or 0.002% or more.

On the other hand, if excessively containing Zr, coarse Zr oxides are formed and sometimes the hydrogen embrittlement resistance falls. For this reason, the Zr content is 0.050% or less. The Zr content may also be 0.030% or less, 0.010% or less, 0.005% or less, or 0.003% or less.

### [La: 0 to 0.050%]

La is an element able to control the form of sulfides by a trace amount in the same way as Mg, etc. The La content may also be 0%, but to obtain such an effect, the La content is preferably 0.0001% or more. The La content may also be 0.0005% or more, 0.001% or more, or 0.002% or more.

On the other hand, if excessively containing La, La oxides are formed and sometimes the hydrogen embrittlement resistance falls. For this reason, the La content is 0.050% or less. The La content may also be 0.030% or less, 0.010% or less, 0.005% or less, or 0.003% or less.

### [Ce: 0 to 0.050%]

Ce is an element able to control the form of sulfides by a trace amount in the same way as Mg, etc. The Ce content may also be 0%, but to obtain such an effect, the Ce content is preferably 0.0001% or more. The Ce content may also be 0.0005% or more, 0.001% or more, or 0.002% or more.

On the other hand, if excessively containing Ce, Ce oxides are formed and sometimes the hydrogen embrittlement resistance falls. For this reason, the Ce content is 0.050% or less. The Ce content may also be 0.030% or less, 0.010% or less, 0.005% or less, or 0.003% or less.

In the steel sheet according to the embodiments of the present invention, the balance besides the above elements is comprised of Fe and impurities. “Impurities” means constituents, etc., entering due to various factors in the production process such as first and foremost the raw materials like ores and scrap, etc., when industrially producing the steel sheet.

The chemical composition of the steel sheet according to the embodiments of the present invention may be measured by a general analysis method. For example, it may be measured using ICP-AES (inductively coupled plasma-atomic emission spectrometry) on the chips based on JIS G 1201: 2014. Specifically, for example, this can be identified by taking a 35 mm square test piece from the steel sheet, grinding this down to the ½ position of sheet thickness, and measuring the ground surface by ICPS-8100 made by Shimadzu Corporation, etc., (measurement device) under conditions based on calibration curves prepared in advance. The C and S, which cannot be measured by ICP-AES, may be measured using the combustion-infrared absorption method, N can be measured using the inert gas fusion-thermal conductivity method, and O may be measured using the inert gas fusion-nondispersive infrared absorption method. If the surface of the steel sheet is provided with a coating layer, the chemical composition may be analyzed after removing the coating layer by machine grinding.

### [Preferable Microstructure of Steel Sheet]

The microstructure of the steel sheet according to the embodiments of the present invention may be any microstructure satisfying the requirement of the tensile strength being 1500 MPa or more. In more detail, the present invention, as explained above, has as its object to provide a steel sheet high in strength and excellent in hydrogen embrittlement resistance of bent parts and achieves this object in a high strength steel sheet having a tensile strength of 1500 MPa or more by controlling the ratio of macro brittle fracture surface at a Charpy impact test at room temperature to 35.0% or less and controlling the average Vickers hardness Hs at a region from at least one surface of the steel sheet down to 10% of sheet thickness to 0.95 time or less the average Vickers hardness Hc at the ½ position of sheet thickness. Therefore, it is clear that the microstructure of the steel sheet is not a technical feature essential in achieving the object of the present invention. Below, a preferable microstructure for a steel sheet having a tensile strength of 1500 MPa or more according to the embodiments of the present invention will be explained in detail, but the explanations are intended to simply illustrate steel sheets having a tensile strength of 1500 MPa or more and are not intended to limit the present invention to the steel sheet having such specific microstructures. Further, in the steel sheet according to the embodiments of the present invention, as explained above, the surface layer parts of the steel sheet are softened, and therefore sometimes the microstructure will differ between the surface layer parts and inside layer part of the steel sheet. Therefore, below, the microstructure at the ½ position of sheet thickness is defined representing parts not softened in the steel sheet.

[Martensite and Tempered Martensite: More than 93.0% in Total]

The microstructure at the ½ position of sheet thickness of the steel sheet is not particularly limited, but may include, by area ratio, martensite and tempered martensite: more than 93.0% in total. By having the predetermined chemical composition explained previously, in particular by having a C content of 0.15% or more and including martensite and tempered martensite by an area ratio of more than 93.0% at the ½ position of sheet thickness, it is possible to reliably achieve a tensile strength of 1500 MPa or more. The area ratio of the total of martensite and tempered martensite may also be 95.0% or more or 97.0% or more. The upper limit on the area ratio of the total of martensite and tempered martensite is not particularly limited and may be 100%. For example, the area ratio of martensite and tempered martensite may be 99.0% or less or 98.0% or less.

[Ferrite: Less than 7.0%]

The microstructure at the ½ position of sheet thickness of the steel sheet is not particularly limited, but may include, by area ratio, ferrite: less than 7.0%. Ferrite is a soft structure, and therefore by limiting the area ratio of ferrite to less than 7.0% as opposed to the more than 93.0% area ratio of the hard structures of martensite and tempered martensite, it is possible to reliably achieve a tensile strength of 1500 MPa or more. The area ratio of ferrite may be 5.0% or less or 3.0% or less, for example, may be 0%. On the other hand, ferrite, as explained above, is a soft structure, and therefore easily deforms and contributes to improvement of the ductility of the steel sheet. Therefore, from the viewpoint of improvement of the ductility of the steel sheet, the area ratio of ferrite may be 1.0% or more or 2.0% or more.

### [Balance Structures: At Least One of Bainite, Pearlite, and Retained Austenite]

The balance structure besides martensite and tempered martensite and ferrite may be, by area ratio, 0%, but if there is a balance structure, the balance structure may be at least one of bainite, pearlite, and retained austenite. The area ratio of the balance structure is not particularly limited, but, for example, may be less than 0 to less than 7.0%, 0 to 5.0%, or 0 to 3.0%. On the other hand, making the area ratio of the balance structure 0% requires sophisticated control in the production process of the steel sheet, and therefore a drop in yield is sometimes invited. Therefore, the area ratio of the balance structure may be 1.0% or more.

### [Identification and Calculation of Microstructure]

### [Martensite and Tempered Martensite]

The microstructure at the ½ position of sheet thickness of the steel sheet is identified and calculated as follows: First, a sample having a sheet thickness cross-section parallel to the rolling direction of the steel sheet is taken and that cross-section is made the examined surface. The examined surface is etched by a Nital reagent. In the etched examined surface, a 100 μm×100 μm region centered at the ½ position of sheet thickness from the steel sheet surface is made the examined region. This examined region is examined at 1000 to 50000× by an electron channeling contrast image using a field emission type scan electron microscope (FE-SEM). An electron channeling contrast image is a technique of detecting differences in crystal orientation in the crystal grains as differences in contrast of the image. The area ratio of the total of martensite and tempered martensite is found from an image captured by this electron channeling contrast. These structures are more difficult to etch than ferrite, and therefore are present as projecting parts on the microstructure examined surface. Tempered martensite is an aggregate of lath-shaped crystal grains. It includes long axis 20 nm or more iron-based carbides inside it. The carbides fall into several variants, i.e., iron-based carbide groups stretched in different directions. Further, retained austenite is also present as projecting parts on the microstructure examined surface. For this reason, by subtracting the area ratios of the projecting parts found in the above order from the area ratio of retained austenite measured by the procedure explained later, it is possible to accurately measure the area ratio of the total of martensite and tempered martensite.

### [Ferrite]

The area ratio of ferrite is found by examining a 100 μm×100 μm region centered at the ½ position of sheet thickness from a steel sheet surface in the same way by the above electron channeling contrast image. In the electron channeling contrast image, a region able to be recognized as contrast with a uniform intermediate brightness (gray) is polygonal ferrite. This is judged as ferrite. Such judgment of brightness is of an extent performed by a person skilled in the art as ordinary examination of structures. Note that a region recognized as such uniform intermediate brightness is a region easily corroded by etching. In surface form, it becomes a recessed part. Eight fields of 35 μm×25 μm electron channeling contrast images were examined by an image analysis method. The area ratios of polygonal ferrite of the different fields are calculated and the average value of these is made the area ratio of ferrite.

### [Bainite, Pearlite, and Retained Austenite]

The area ratio of retained austenite is calculated by measurement using X-rays. First, part of the sample from the sheet surface down to the ½ position of sheet thickness in the sheet thickness direction is removed by mechanical polishing and chemical polishing. Next, the polished sample is calculated for the percentage of structure of retained austenite from the integrated intensity ratios of the diffraction peaks of (200), (211) of the bcc phase and (200), (220), (311) of the fcc phase obtained using MoKα rays as characteristic X-rays. This is made the area ratio of the retained austenite. Further, the area ratios of pearlite and bainite are found from images captured by the above electron channeling contrast. Pearlite is a structure of plate shaped carbide and ferrite lined up. Further, bainite is an aggregate of lath-shaped crystal grains and either does not contain iron-based carbides of long axes of 20 nm or more inside it or contains iron-based carbides of long axes of 20 nm or more inside it, wherein the carbides fall under single variants, i.e., a group of iron-based carbides stretched in the same direction. Here, the “group of iron-based carbides stretched in the same direction” means differences in the stretched direction of the iron-based carbides of within 5°.

### [Hs/Hc≤0.95]

In the embodiments of the present invention, the average Vickers hardness Hs in a region from at least one surface of the steel sheet (if there is a plating layer or other coating layer on the surface of the steel sheet, the interface of the coating layer and the steel sheet) down to 10% of sheet thickness is 0.95 time or less the average Vickers hardness Hc at the ½ position of sheet thickness. In general, in a 1500 MPa or more high strength steel sheet, sometimes a sufficient bendability cannot be obtained. Further, at bent parts, a relatively large plastic strain is imparted, and therefore there is the problem that hydrogen embrittlement easily occurs. However, according to the embodiments of the present invention, by controlling the average Vickers hardness Hs in a region from at least one surface, preferably both surfaces, of the steel sheet down to 10% of sheet thickness to 0.95 time or less the average Vickers hardness Hc at the ½ position of sheet thickness so soften the surface layers of the steel sheet, it is possible to remarkably improve the bendability and make the upper limit of the amount of hydrogen at which hydrogen embrittlement is not caused at a bent part, i.e., the critical hydrogen content, increase. Further, as explained above, while it is preferable that Hs/Hc≤0.95 be satisfied at both the surfaces of the steel sheet, an embodiment where Hs/Hc≤0.95 is satisfied at only one surface of the steel sheet also naturally is encompassed in the present invention. The reason is that if Hs/Hc≤0.95 is satisfied even at either one surface, compared to if Hs/Hc≤0.95 is not satisfied at both surfaces, it is possible to remarkably improve the bendability and increase the critical hydrogen content at a bent part. Therefore, by combination with control of the ratio of macro brittle fracture surface explained in detail later, even in a steel sheet having an extremely high tensile strength of 1500 MPa or more, it is possible to remarkably improve the hydrogen embrittlement resistance of the bent parts. From the viewpoint of enhancing these effects, Hs is preferably a value smaller than Hc. For example, Hs may be 0.92 time or less, 0.90 time or less, 0.88 time or less, 0.85 time or less, 0.82 time or less, 0.80 time or less, 0.78 time or less, 0.75 time or less, or 0.70 time or less Hc. On the other hand, the lower limit is not particularly limited. Any suitable value can be selected. For example, Hs may be 0.20 time or more or 0.30 time or more Hc, but from the viewpoint of securing a higher strength of the steel sheet, for example, Hs may be 0.40 time or more, 0.45 time or more, or 0.50 time or more Hc.

### [Measurement of Hs and Hc]

In the present invention, the “average Vickers hardness Hs in a region from a surface down to 10% of sheet thickness” and the “average Vickers hardness Hc at the ½ position of sheet thickness” are determined in the following way: The Vickers hardness test is performed based on JIS Z 2244-1: 2020. First, a test piece is cut out from any position 50 mm or more from end parts of the steel sheet so that a cross-section vertical to the surface (sheet thickness cross-section) can be observed. The Vickers hardnesses at 10 points of depth position when dividing the span from a depth position of 2 μm from the surface of the test piece (if there is a plating layer or other coating layer on the surface of the steel sheet, the interface of the coating layer and the steel sheet) down to a depth position of 1/10 the sheet thickness into nine equal parts are measured by an indentation load of 10 g. The average value of these is determined as the average Vickers hardness Hs at the region from the surface down to 10% of sheet thickness. Next, the Vickers hardness at the ½ position of sheet thickness of the test piece is measured by an indentation load of 10 g, then the Vickers hardnesses at a total of 5 points or more, for example, 10 points, are measured by an indentation load of 10 g in the same way in a direction vertical to the sheet thickness direction from that position and on a line parallel to the rolling direction. The average value of these is determined as the average Vickers hardness Hc at the ½ position of sheet thickness. The interval between measurement points at the ½ position of sheet thickness is preferably a distance of 4 times or more an indentation. A “distance of 4 times or more an indentation” means a distance of 4 times or more the length of a diagonal at a rectangular shaped opening of an indentation formed by a diamond indenter at the time of measurement of the Vickers hardness. The value of Hs/Hc is determined based on the thus obtained Hs and Hc. If the surface layer parts of both sides of the steel sheet are softened, the average Vickers hardness Hs is determined at the region from the surface of the other side down to 10% of sheet thickness by measurement in the same way as explained above.

### [0.10≤Cs/Cc≤0.90]

In the embodiments of the present invention, the average carbon concentration Cs in a region from at least one surface of the steel sheet (if there is a plating layer or other coating layer on the surface of the steel sheet, the interface of the coating layer and the steel sheet) down to 10% of sheet thickness is preferably 0.10 to 0.90 time the average carbon concentration Cc of the parent material. By controlling the average carbon concentration Cs in a region from at least one surface of the steel sheet down to 10% of sheet thickness to 0.90 time or less the average carbon concentration Cc of the parent material, it is possible to reliably control the average Vickers hardness Hs in a region from at least one surface of the steel sheet down to 10% of sheet thickness to 0.95 time or less the average Vickers hardness Hc at the ½ position of sheet thickness. Therefore, in addition to improvement of the hydrogen embrittlement resistance, this is extremely effective from the viewpoint of improvement of the bendability as well. Further, while it is preferable to control the Cs at both the surfaces of the steel sheet to 0.90 time or less the average carbon concentration Cc of the parent material, i.e., to satisfy Cs/Cc≤0.90 at both surfaces of the steel sheet, an embodiment where Cs/Cc≤0.90 is satisfied at only at least one surface of the steel sheet also naturally is encompassed in the present invention. The reason is that if Cs/Cc≤0.90 is satisfied even at either one surface, compared to if Cs/Cc≤0.90 is not satisfied at both surfaces, it is possible to achieve sufficient effects. From the viewpoint of further improving these effects, Cs is preferably a value smaller than Cc. For example, Cs may be 0.85 time or less, 0.80 time or less, 0.75 time or less, 0.70 time or less, 0.65 time or less, 0.60 time or less, or 0.55 time or less Cc. On the other hand, from the viewpoint of securing a higher strength of the steel sheet, Cs is preferably 0.10 time or more Cc. For example, it may be 0.15 time or more, 0.20 time or more, 0.25 time or more, 0.30 time or more, 0.35 time or more, or 0.40 time or more Cc.

### [Measurement of Cs and Cc]

In the present invention, the “average carbon concentration Cs in a region from a surface down to 10% of sheet thickness” and the “average carbon concentration Cc of the parent material” are determined in the following way using a high frequency glow discharge spectrometer (GDS). Specifically, the method of rendering the surface of the steel sheet an Ar atmosphere, applying voltage to cause the generation of glow plasma, and in that state sputtering the steel sheet surface while analyzing it in the depth direction is used. Further, the elements contained in the material are identified from the emitted spectral wavelengths unique to elements generated by excitation of atoms in the glow plasma and the emission intensities of the identified elements are estimated. The depth direction data can be estimated from the sputter time. Specifically, it is possible to convert sputter time to sputter depth by using standard samples in advance to find the relationship between the sputter time and sputter depth. Therefore, it is possible to define the sputter depth converted from the sputter time as the depth from the surface of the material. The obtained emission intensity is converted to mass % by preparing calibration curves. The average carbon concentration at the region from the surface (if there is a plating layer or other coating layer on the surface of the steel sheet, the interface of the coating layer and the steel sheet) down to 0.1 to 10% of sheet thickness measured in this way is determined as Cs. On the other hand, the average value of the emission intensities in a range of depth where the emission intensities of carbon are sufficiently stable is calculated. For example, the average value of the emission intensities of C in the region from the surface of the steel sheet down to 15 to 25% of the sheet thickness is calculated. This is determined as the average carbon concentration Cc of the parent material. The value of Cs/Cc is determined based on the thus obtained Cs and Cc. If the surface layer parts of both sides of the steel sheet are softened, the average carbon concentration Cs is determined at the region from the surface of the other side down to 10% of sheet thickness by measurement in the same way as explained above.

The control to 0.10≤Cs/Cc≤0.90 by decarburization shown above is merely one preferable means for achieving the desired softening at the surface layer parts of the steel sheet, i.e., Hs/Hc≤0.95. In other words, the feature of Hs/Hc≤0.95 according to embodiments of the present invention can be achieved by any suitable means known to persons skilled in the art. For example, the feature of Hs/Hc≤0.95 can be achieved by suitably heat treating, etc., the structures at the surface layer parts of the steel sheet to reform the structures to coarser than the inside of the steel sheet and thereby soften the surface layer parts. Alternatively, further, the feature of Hs/Hc≤0.95 can be achieved by forming the structures at the surface layer parts of the steel sheet with softer structures compared with the inside of the steel sheet.

### [Ratio of Macro Brittle Fracture Surface at Charpy Impact Test at Room Temperature: 35.0% or Less]

In the steel sheet according to the embodiments of the present invention, the ratio of macro brittle fracture surface at a Charpy impact test at room temperature (about 25° C.) is 35.0% or less. In the present invention, the “ratio of macro brittle fracture surface” means the ratio of brittle fracture surface at the parent material part other than the softened parts of the steel sheet surface layers. The inventors discovered that the ratio of macro brittle fracture surface at a Charpy impact test at room temperature is closely related to the embrittlement of the prior austenite grain boundaries acting as starting points of hydrogen embrittlement cracking in the microstructure and discovered that if the resistance to embrittlement of the parent material part is high, it is possible to improve the hydrogen embrittlement resistance of the steel sheet. Specifically, by limiting the ratio of such macro brittle fracture surface at a Charpy impact test at room temperature to 35.0% or less, it is possible to reliably improve the hydrogen embrittlement resistance of the steel sheet. Further, by combining this with the predetermined softening at the surface layer parts of the steel sheet explained above, it is possible to remarkably improve the hydrogen embrittlement resistance at bent parts even in a steel sheet having an extremely high tensile strength of 1500 MPa or more. From the viewpoint of improvement of the hydrogen embrittlement resistance, the smaller the ratio of macro brittle fracture surface at a Charpy impact test at room temperature, the better. For example, it may be 30.0% or less, 25.0% or less, 20.0% or less, or 15.0% or less. On the other hand, the lower limit is not particularly limited and may be 0%. For example, the ratio of macro brittle fracture surface at a Charpy impact test at room temperature may be 0.1% or more, 0.2% or more, 0.4% or more, 0.6% or more, 0.8% or more, 1.0% or more, 3.0% or more, or 5.0% or more.

### [Measurement of Ratio of Macro Brittle Fracture Surface]

In the present invention, the ratio of macro brittle fracture surface at a Charpy impact test at room temperature is determined as follows: First, a V-notch test piece of a length of 55 mm, width of 10 mm, and predetermined steel sheet thickness prescribed in JIS Z 2242: 2018 is taken from the steel sheet. The softened parts of the steel sheet surface layers (about 10% of sheet thickness per side, if both surfaces of the steel sheet are softened, about 10% at each of the surfaces of the steel sheet) are removed by grinding. If the thickness of the steel sheet after removal of the surface layer parts is more than 2.5 to 5 mm, two sheets are superposed and fastened together by bolts to obtain the thickness of the test piece. If the thickness of the steel sheet is 2.5 mm or less, three sheets are superposed and fastened together by bolts to obtain the thickness of the test piece. The longitudinal direction of the test piece is the sheet width direction. A notch is made so that fractures propagate in the rolling direction. Based on this V-notch test piece, a Charpy impact test at room temperature (about 25° C.) is performed based on the provisions of JIS Z 2242: 2018. Next, the fracture surface of the test piece after the Charpy impact test is examined and the ratio of the area of brittle fracture surface with respect to the area of all fracture surface is calculated by image analysis software. This is determined as the ratio of macro brittle fracture surface at a Charpy impact test at room temperature.

[Amount of Segregation of P at Prior Austenite Grain Boundaries from ⅛ Position of Sheet Thickness to ½ Position of Sheet Thickness: 3.5 Atm % or Less]

P is an element segregating at the prior austenite grain boundaries and promoting embrittlement of the grain boundaries. For that reason, it is an extremely important element in controlling the above ratio of macro brittle fracture surface. This time, the inventors discovered that by reducing the amount of segregation of P at the prior austenite grain boundaries from the ⅛ position of sheet thickness of the steel sheet to the ½ position of sheet thickness to 3.5 atm % or less, it is possible to reliably control the ratio of macro brittle fracture surface to 35.0% or less and as a result possible to remarkably improve the hydrogen embrittlement resistance of the steel sheet. From the viewpoint of improvement of the hydrogen embrittlement resistance, the lower the amount of segregation of P at the prior austenite grain boundaries, the better. For example, it may be 3.2 atm % or less, 3.0 atm % or less, 2.5 atm % or less, or 2.0 atm % or less. On the other hand, the lower limit is not particularly limited. Ideally, it is 0 atm %. However, reducing the P content of the steel sheet to 0 mass % or a level close to that is difficult in terms of production costs. In the same way, reducing the amount of segregation of P at the prior austenite grain boundaries from the ⅛ position of sheet thickness of the steel sheet to the ½ position of sheet thickness down to 0 atm % is also difficult in practice. Therefore, the amount of segregation of P may, for example, be 0.1 atm % or more, 0.2 atm % or more, 0.3 atm % or more, 0.5 atm % or more, or 1.0 atm % or more.

### [Measurement of Amount of Segregation of P]

In the present invention, the amount of segregation of P at the prior austenite grain boundaries from the ⅛ position of sheet thickness of the steel sheet to the ½ position of sheet thickness is determined in the following way. First, a test piece is taken from a position 50 mm or more from the end faces of the steel sheet. At this time, the front and back surfaces of the test piece are finished by mechanical grinding. Further, if the steel sheet surface has coating layers (for example, plating layers), the coating layers are removed and the front and back surfaces of the test piece of the steel sheet are finished by mechanical grinding. At this time, if the ⅛ position of sheet thickness to the ½ position of sheet thickness can be measured, the sheet thickness is not particularly designated, but the front and back surfaces of the test piece may also be mechanically ground by the same amounts so that the sheet thickness becomes 1.2 mm. The test piece is worked to a length of 20 mm and a width of 3.2 mm and given a V-notch of an angle of 45° at a position of a length 11.5 mm. The test piece is immersed in a 20%-ammonium thiocyanate solution. At this time, the time of immersion is not particularly limited. Any condition at which the prior austenite grain boundaries are exposed when setting the test piece in an Auger electron spectroscope and fracturing is possible. For example, it may be 48 hours. Within 10 minutes after the end of immersion, the front and back surfaces of the test piece are galvanized. After plating, the test piece is quickly supplied to Auger electron spectroscopy and fractures. At this time, the time from after plating to destruction of the test piece is preferably within 1.5 hours, more preferably is within 0.5 hour. The test piece is set in the Auger electron spectroscope and breaks from the notch part of the test piece to expose the prior austenite grain boundaries. At this time, the apparatus may be any electron emission type Auger electron spectroscope. The model is not particularly limited. A PHI680 made by ULVAC-PHI may be used. As measurement conditions, the acceleration voltage may be 10 keV and the irradiation current may be 10 nA. An electron beam is fired at the exposed prior austenite grain boundaries by a 1 to 30 kV acceleration voltage to measure the atm % of P at the grain boundaries. The measurement is conducted at 10 locations of prior austenite grain boundaries from the ⅛ position of sheet thickness from the surface to the ½ position of sheet thickness. To prevent contamination of the grain boundaries, the measurement is preferably quickly finished after breakage. The measurement may be completed within 30 minutes. The average value of the atm % of the P obtained is calculated and determined as the amount of segregation of P at the prior austenite grain boundaries from the ⅛ position of sheet thickness of the steel sheet to the ½ position of sheet thickness.

### [Sheet Thickness]

The steel sheet according to the embodiments of the present invention generally has a sheet thickness of 0.6 to 6.0 mm. While not particularly limited, the sheet thickness may be 1.0 mm or more, 1.2 mm or more, or 1.4 mm or more and/or may be 5.0 mm or less, 4.0 mm or less, 3.0 mm or less, or 2.5 mm or less.

### [Coating Layer]

The steel sheet according to embodiments of the present invention may further include, for the purpose of improvement of the corrosion resistance, a coating layer, for example, a plating layer, on at least one of the surfaces, preferably both of the surfaces. While not particularly limited, the coating layer, for example, includes at least one selected from the group consisting of zinc, aluminum, magnesium, and alloys thereof. More specifically, the coating layer may be a hot dip coating layer or electroplated layer. The hot dip coating layer includes, for example, a hot dip galvanized layer, hot dip galvannealed layer, hot dip aluminum coating layer, hot dip Zn—Al alloy coating layer, hot dip Zn—Al—Mg alloy coating layer, hot dip Zn—Al—Mg—Si alloy coating layer, etc. The electroplating layer includes, for example, an electrogalvanized layer, electro Zn—Ni alloy plating layer, etc. Preferably, the coating layer is a hot dip galvanized layer, hot dip galvannealed layer, or electrogalvanized layer. The amount of deposition of the coating layer is not particularly limited and may be a general amount of deposition.

### [Mechanical Properties]

The steel sheet according to the embodiments of the present invention has a tensile strength of 1500 MPa or more. The tensile strength is preferably 1600 MPa or more, 1700 MPa or more, or 1800 MPa or more. According to the steel sheet according to the embodiments of the present invention, despite having such an extremely high tensile strength, the combination of the suitable control of the ratio of macro brittle fracture surface explained above and predetermined softening at the surface layer parts of the steel sheet enables remarkable improvement of the hydrogen embrittlement resistance of bent parts. The upper limit of the tensile strength is not particularly limited, but, for example, the tensile strength may be 2300 MPa or less, 2200 MPa or less, or 2100 MPa or less. Further, according to the steel sheet according to the embodiments of the present invention, excellent bendability can be achieved. More specifically, a total elongation of 4.0% or more can be achieved. The total elongation is preferably 5.0% or more, more preferably 6.0% or more, or 7.0% or more. The upper limit is not particularly limited, but for example the total elongation may also be 12.0% or less or 10.0% or less. The tensile strength and the total elongation are measured by conducting a tensile test compliant with JIS Z 2241: 2011 based on a JIS No. 5 test piece taken from an orientation in which the longitudinal direction of the test piece becomes parallel with the perpendicular direction to rolling of the steel sheet.

The steel sheet according to the embodiments of the present invention, as explained above, despite having an extremely high tensile strength of 1500 MPa or more, is excellent in hydrogen embrittlement resistance and furthermore excellent in bendability, and therefore, for example, is extremely useful for use as a frame member of an automobile, bumpers, and other structural members and reinforcing members requiring strength and is extremely suited for applications in which high bendability is sought in addition to high strength.

### <Method of Production of Steel Sheet>

Next, a preferable method of production of the steel sheet according to the embodiments of the present invention will be explained. The following explanation is intended to illustrate the characteristic method for producing the steel sheet according to the embodiments of the present invention and is not intended to limit the steel sheet to ones produced by the method of production such as explained below.

The method of production of the steel sheet according to embodiments of the present invention is characterized by including
a hot rolling step including heating a slab having the chemical composition explained above in relation to the steel sheet to a temperature of 1100 to 1300° C., then finish rolling it, cooling the finish rolled steel sheet by an average cooling speed of 20° C./s or more down to 500° C. or less, and coiling the result, wherein an end temperature of the finish rolling is 850 to 1050° C.,
a pickling step of pickling the obtained hot rolled steel sheet,
a cold rolling step of cold rolling the pickled hot rolled steel sheet by a rolling reduction of 35 to 80%,
an annealing step of annealing the obtained cold rolled steel sheet, wherein the annealing includes heating the cold rolled steel sheet to 700° C. or more in an atmosphere with a dew point of −30.0 to 10.0° C. and a hydrogen concentration of 1.0 to 10.0%, holding it at a maximum heating temperature of 830 to 900° C. for 20 to 150 seconds, then limiting the dwell time in a temperature region of 400 to 600° C. to 2 to 350 seconds, and
a cooling step of cooling the cold rolled steel sheet down to room temperature by an average cooling speed of 20° C./s or more. Below, each step will be explained in detail.

### [Hot Rolling Step]

### [Heating of Slab]

First, a slab having the chemical composition explained above in relation to the steel sheet is heated. The slab used is preferably cast by the continuous casting method from the viewpoint of productivity, but may also be produced by the ingot making method or the thin slab casting method. The slab used contains relatively large amounts of alloy elements for obtaining a high strength steel sheet. For this reason, it is necessary to heat the slab before sending it on to hot rolling so as to make the alloy elements dissolve in the slab. If the heating temperature is less than 1100° C., the alloy elements will not sufficiently dissolve in the slab and coarse alloy carbides will remain resulting sometimes in brittle cracks during hot rolling. For this reason, the heating temperature is preferably 1100° C. or more. The upper limit of the heating temperature is not particularly limited, but from the viewpoint of the capacity of the heating facilities and productivity is preferably 1300° C. or less.

### [Rough Rolling]

In the present method, for example, the heated slab may be rough rolled before the finish rolling so as to adjust the sheet thickness, etc. The rough rolling need only be able to secure the desired sheet bar dimensions. The conditions are not particularly limited.

### [Finish Rolling]

The heated slab or the slab additionally rough rolled according to need is next finish rolled. The slab used in the above way contains relatively large amounts of alloy elements, and therefore it is necessary to increase the rolling load at the time of hot rolling. For this reason, the hot rolling is preferably performed at a high temperature. In particular, the end temperature of the finish rolling is important in control of the metallostructure of the steel sheet. If the end temperature of the finish rolling is low, the metallostructure becomes uneven and the shapeability sometimes falls. For this reason, the end temperature of the finish rolling is preferably 850° C. or more. On the other hand, to suppress coarsening of the austenite, the end temperature of the finish rolling is preferably 1050° C. or less.

### [Cooling and Coiling]

Next, the finish rolled steel sheet is cooled by an average cooling speed of 20° C./s or more down to 500° C. or less and coiled. If the average cooling speed is less than 20° C./s or the coiling temperature is more than 500° C., in the hot rolling step, segregation of P occurs, the hot rolled steel sheet becomes brittle, and sometimes subsequent cold rolling becomes difficult. For example, the average cooling s peed is preferably 25° C./s or more and the coiling time is preferably 480° C. or less.

### [Pickling Step]

Next, the obtained hot rolled steel sheet is pickled to remove the oxide scale formed on the surfaces of the hot rolled steel sheet. The pickling should be performed under conditions suitable for removing the oxide scale. This may be done one time or may be done divided into several times so as to reliably remove the oxide scale.

### [Cold Rolling Step]

The pickled hot rolled steel sheet is cold rolled in the cold rolling step by a rolling reduction of 35 to 80%. By the rolling reduction of the cold rolling being 35% or more, it is possible to keep the shape of the cold rolled steel sheet flat and keep down a drop in ductility in the final product. The rolling reduction of the cold rolling is preferably 50% or more. On the other hand, by the rolling reduction of the cold rolling being 80% or less, it is possible to prevent the rolling load from becoming excessive and the rolling from becoming difficult. The rolling reduction of the cold rolling is preferably 70% or less. The number of rolling passes and the rolling reduction of each pass are not particularly limited and need only be suitably set so that the rolling reduction of the cold rolling as a whole becomes the above range.

### [Annealing Step]

[Heating to 700° C. Or More in Atmosphere with Dew Point of −30.0 to 10.0° C. And Hydrogen Concentration of 1.0 to 10.0%]

The obtained cold rolled steel sheet is heated in, for example, a heating furnace and soaking furnace of a continuous annealing line in an atmosphere with a dew point of −30.0 to 10.0° C. and a hydrogen concentration of 1.0 to 10.0% (for example nitrogen balance) to a temperature of 700° C. or more for annealing. By annealing in such an atmosphere under high temperature conditions, it is possible to suitably decarburize of the surface layer parts the steel sheet. As a result, by controlling the average carbon concentration Cs in the region from at least one surface, in particular both surfaces, in the finally obtained steel sheet down to 10% of sheet thickness to a range of 0.10 to 0.90 time the average carbon concentration Cc of the parent material (0.10≤Cs/Cc≤0.90), it is possible to achieve the desired softening at the surface layer parts of the steel sheet, i.e., make the average Vickers hardness Hs in the region from at least one surface, in particular both surfaces, in the steel sheet down to 10% of sheet thickness 0.95 time or less the average Vickers hardness Hc at the ½ position of sheet thickness (Hs/Hc≤0.95). If the dew point is less than −30.0° C. or the hydrogen concentration is more than 10.0% and/or the heating temperature is less than 700° C., the decarburization of the surface layer parts cannot sufficiently proceed, and therefore even if suitably performing the following steps, it is not possible to achieve 0.10≤Cs/Cc≤0.90 at the finally obtained steel sheet and not possible to achieve the desired surface layer softening, i.e., Hs/Hc≤0.95. On the other hand, if the dew point is more than 10.0° C. and/or the hydrogen concentration is less than 1.0%, depending on the C content, the decarburization proceeds too much and in the finally obtained steel sheet, a desired tensile strength of 1500 MPa or more can no longer be achieved. From the viewpoint of securing the desired surface layer softening and strength, preferably the dew point is −20.0 to 8.0° C., the hydrogen concentration is 1.5 to 10.0%, and the heating temperature is 750° C. or more.

For example, it is also possible to make just one surface layer part of the steel sheet satisfy Hs/Hc≤0.95. As the specific method for realizing this, for example, at the time of the annealing step, two cold rolled steel sheets may be superposed and annealed under the conditions explained above to thereby decarburize and soften only one surface layer part of each steel sheet.

### [Holding for 20 to 150 Second at Maximum Heating Temperature of 830 to 900° C.]

Next, the cold rolled steel sheet is further heated in the previously described dew point and hydrogen concentration atmosphere to a maximum heating temperature of 830 to 900° C. and held at the maximum heating temperature for 20 to 150 seconds. Due to this, austenizing is promoted and in the subsequent cooling step it is possible to obtain the desired hard structures comprised of martensite, etc., whereby it is possible to reliably achieve a tensile strength of 1500 MPa or more. Furthermore, in such a temperature range, since the temperature is high, the diffusion of P is relatively fast and it is possible to suppress or reduce segregation of P to the prior austenite grain boundaries in the finally obtained steel sheet. As a result, it is possible to control the amount of segregation of P at the prior austenite grain boundaries from the ⅛ position of sheet thickness of the steel sheet to the ½ position of sheet thickness to 3.5 atm % or less and in turn possible to make the ratio of macro brittle fracture surface in a Charpy impact test at room temperature 35.0% or less. In addition, by holding in such a temperature range for 20 to 150 seconds, it is possible to sufficiently decarburize the surface layer parts of the steel sheet, and therefore it is possible to achieve the desired surface layer softening with an Hs/Hc of 0.95 or less in the finally obtained steel sheet.

If the maximum heating temperature is less than 830° C., the austenizing becomes insufficient, martensite and other hard structures cannot be sufficiently obtained at the finally obtained steel sheet, and a tensile strength of 1500 MPa or more can no longer be achieved. In addition, the diffusion of P becomes relatively slow, whereby sometimes it is not possible to sufficiently suppress the grain boundary segregation of P at the final microstructure. In this case, it is no longer possible to control the ratio of the macro brittle fracture surface to 35.0% or less. On the other hand, if the maximum heating temperature exceeds 900° C., the martensite becomes coarser at the final microstructure. Due to the accompanying drop in the grain boundary area, even if the overall amount of segregation of P is equal, the amount of segregation of P at the prior austenite grain boundaries relatively increases. As a result, it similarly becomes no longer possible to control the ratio of the macro brittle fracture surface to 35.0% or less. Preferably, the maximum heating temperature is 835 to 896° C.

Further, if the holding time at the maximum heating temperature is less than 20 seconds, the austenizing becomes insufficient, martensite and other hard structures cannot be sufficiently obtained at the final microstructure, and a tensile strength of 1500 MPa or more can no longer be achieved. In addition, the surface layer parts of the steel sheet cannot be sufficiently decarburized, and therefore it is no longer possible to achieve the desired surface layer softening with an Hs/Hc of 0.95 or less. On the other hand, if the holding time at the maximum heating temperature exceeds 150 seconds, the time becomes too long in the 830 to 900° C. region, and therefore sometimes segregation of P at the grain boundaries increases. In this case, it is no longer possible to control the above ratio of macro brittle fracture surface to 35.0% or less. Further, the holding time at a high temperature becomes longer, and therefore decarburization excessively proceeds and a desired tensile strength of 1500 MPa or more becomes no longer able to be achieved at the finally obtained steel sheet. Preferably, the holding time is 23 to 146 seconds.

### [Dwell Time at Temperature Region of 400 to 600° C.: 2 to 350 Seconds]

Next, before the cooling step, it is important to limit the dwell time of the cold rolled steel sheet at a temperature region of 400 to 600° C. to 2 to 350 seconds. If the temperature is relatively high, diffusion of P becomes dominant, and therefore it is possible to suppress or reduce segregation of P at the grain boundaries. However, at the relatively low temperature region of 400 to 600° C., diffusion of P becomes slower, and therefore segregation of P at the grain boundaries easily occurs. Therefore, to suppress or reduce grain boundary segregation of P, it is necessary to limit the dwell time of the cold rolled steel sheet in the temperature region of 400 to 600° C. to within a predetermined range. Specifically, it is important to limit the dwell time to 350 seconds or less. Due to this, it is possible to reliably control the amount of segregation of P at the prior austenite grain boundaries from the ⅛ position of sheet thickness of the steel sheet to the ½ position of sheet thickness to 3.5 atm % or less and in turn possible to make the ratio of macro brittle fracture surface at a Charpy impact test at room temperature 35.0% or less. If the dwell time in the temperature region of 400 to 600° C. is more than 350 seconds, the segregation of P at the prior austenite grain boundaries of the final microstructure becomes particularly remarkable and it is impossible to control the above ratio of macro brittle fracture surface to 35.0% or less. To reliably suppress grain boundary segregation of P, the dwell time is preferably 300 seconds or less. From the viewpoint of suppression of grain boundary segregation of P, the shorter the dwell time, the better, but reduction to close to 0 second is practically impossible. Therefore, the lower limit of the dwell time is 2 seconds.

### [Cooling Down to Room Temperature by Average Cooling Speed of 20° C./s or More]

Finally, after the annealing step, the cold rolled steel sheet is cooled in the next cooling step down to room temperature by an average cooling speed of 20° C./s or more. Due to this, it is possible to make the final microstructure hard structures mainly comprised of martensite and thereby reliably achieve a tensile strength of 1500 MPa or more. On the other hand, if the average cooling speed is less than 20° C./s, in the cooling step, bainite is formed in comparatively large amounts and sufficient tensile strength can no longer be achieved.

### [Coating Step]

For the purpose of improving the corrosion resistance, etc., the surface of the cold rolled steel sheet may be coated. The coating treatment may be hot dip coating, alloyed hot dip coating, electroplating, or other treatment. For example, as the coating treatment, the steel sheet may be hot dip galvanized. After hot dip galvanization, it may also be alloyed. The coating layer, for example, includes at least one selected from the group consisting of zinc, aluminum, magnesium, and alloys thereof. More specifically, the coating layer may also be a hot dip coated layer or electroplated layer. The hot dip coated layer includes, for example, a hot dip galvanized (GI) layer, a hot dip galvannealed (GA) layer, hot dip aluminum coated layer, hot dip Zn—Al alloy coated layer, hot dip Zn—Al—Mg alloy coated layer, hot dip Zn—Al—Mg—Si alloy coated layer, etc. The electroplated layer includes, for example, an electrogalvanized layer, electro Zn—Ni alloy plated layer, etc. Preferably, the coating layer is a hot dip galvanized layer, hot dip galvannealed layer, or electrogalvanized layer. The specific conditions of the coating treatment and alloying treatment are not particularly limited and may be any suitable conditions known to persons skilled in the art.

Below, examples will be used to explain the present invention in more detail, but the present invention is not limited to these examples in any way.

### EXAMPLES

In the following examples, the steel sheet according to the embodiments of the present invention was produced under various conditions, and the tensile strength, the total elongation, and hydrogen embrittlement resistance of the steel sheet were investigated.

### Examples A

First, molten steels were cast by the continuous casting method to form slabs having the various chemical compositions shown in Table 1. Each of these slabs was heated to 1230° C. and hot rolled. The hot rolling was performed by rough rolling and finish following. The end temperature of the finish rolling was 940° C. Next, the finish rolled steel sheets were cooled by a 30° C./s average cooling speed down to 420° C. and coiled. Next, the obtained hot rolled steel sheet having the 2.6 mm sheet thickness was pickled, then was cold rolled by a rolling reduction of 45% to obtain a cold rolled steel sheet having a 1.4 mm sheet thickness. Next, the obtained cold rolled steel sheet was heated to 700° C. temperature or more in an atmosphere with a dew point of −2.0° C. and hydrogen 6.0% (nitrogen balance) and held at a 860° C. maximum heating temperature for 90 seconds to thereby sufficiently decarburize the surface layer parts at the two sides of the steel sheet, then the dwell time in the temperature region of 400 to 600° C. was adjusted to become 180 seconds. Finally, the cold rolled steel sheet was cooled down to room temperature by a 30° C./s average cooling speed, then, as coating treatment, was suitably subjected to hot dip galvanization (GI) or hot dip galvannealing (GA).

The properties of the obtained steel sheet were measured and evaluated by the following methods.

[Tensile Strength (TS) and Total Elongation (t-El)]

The tensile strength (TS) and the total elongation (t-El) were measured by conducting a tensile test compliant with JIS Z 2241: 2011 based on a JIS No. 5 test piece taken from an orientation in which the longitudinal direction of the test piece becomes parallel with the perpendicular direction to rolling of the steel sheet.

### [Evaluation of Hydrogen Embrittlement Resistance]

The hydrogen embrittlement resistance at bent parts of the obtained steel sheet was evaluated by the following method: Specifically, first, the steel sheet was sheared by a clearance of 12.5%, then was subjected to a U-bending test by 8R. A strain gauge was attached to the center of the test piece and the two ends of the test piece were fastened by bolts, and stress was applied. The imparted stress was calculated from the strain of the strain gauge monitored. As the load stress, stress corresponding to 80% of the tensile strength (TS) was imparted. This is because the residual stress introduced at the time of shaping is considered to correspond to the tensile strength of the steel sheet. The obtained U-bending test piece was immersed in a liquid temperature 35° C. pH2 HCl aqueous solution, then held there for 72 hours and investigated for any cracks. The lower the pH of the HCl aqueous solution and further the longer the immersion time, the greater the amount of hydrogen penetrating the steel sheet, and therefore the tougher the conditions of the hydrogen embrittlement environment. Cases where a crack of a length exceeding 1 mm was observed in the U-bending test piece after immersion were evaluated as failing (NG), while cases where a crack of a length exceeding 1 mm was not observed in the U-bending test piece (i.e., no crack existed or even if a crack existed, that crack was 1 mm or less) were evaluated as passing (OK).

Cases where the tensile strength (TS) was 1500 MPa or more and the hydrogen embrittlement resistance was evaluated as “OK” were evaluated as steel sheets high in strength and excellent in hydrogen embrittlement resistance of bent parts. The results are shown in Table 2. In Table 2 and the later shown Table 4, the values of Hs/Hc and Cs/Cc only show values calculated based on the average Vickers hardness Hs and average carbon concentration Cs at a region from one surface of the steel sheet down to 10% of the sheet thickness. However, all of the steel sheets are produced by the same processing at the two sides, and therefore the values of Hs and Cs are substantially the same at the two sides of the steel sheets. It was actually confirmed at several of the steel sheets that these values were the same at the two sides of the steel sheets. Further, in Table 2 and the later shown Table 4, the balance structures were bainite, pearlite, and/or retained austenite.

### [Table 1-1]

TABLE 1-1

| | Chemical composition (mass %), balance: Fe and impurities | | | | | | | | | | | | | |
|---|---|---|---|---|---|---|---|---|---|---|---|---|---|---|
| No. | C | Si | Mn | P | S | Al | N | O | Co | Ni | Mo | Cr | Ti | B |
| A | 0.19 | 1.89 | 1.09 | 0.0032 | 0.0059 | 0.955 | 0.017 | 0.0052 | 0.1090 | | 0.430 | | | |
| B | 0.20 | 0.85 | 2.51 | 0.0174 | 0.0018 | 0.376 | 0.002 | 0.0133 | | | | | | |
| C | 0.25 | 1.28 | 2.88 | 0.0129 | 0.0115 | 0.258 | 0.019 | 0.0044 | | | | 1.046 | | 0.0086 |
| D | 0.35 | 0.34 | 0.84 | 0.0170 | 0.0106 | 0.306 | 0.013 | 0.0145 | | | | | | |
| E | 0.33 | 1.76 | 1.72 | 0.0179 | 0.0005 | 0.545 | 0.016 | 0.0030 | | 0.173 | | | | |
| F | 0.39 | 1.41 | 1.54 | 0.0136 | 0.0028 | 0.602 | 0.009 | 0.0131 | | | | | | |
| G | 0.31 | 0.29 | 1.37 | 0.0105 | 0.0134 | 0.751 | 0.012 | 0.0070 | | | | | 0.232 | 0.0043 |
| H | 0.27 | 1.28 | 3.02 | 0.0120 | 0.0190 | 0.877 | 0.007 | 0.0158 | | | 0.944 | | | |
| I | 0.38 | 1.49 | 2.70 | 0.0011 | 0.0090 | 0.533 | 0.009 | 0.0052 | 0.1630 | | | 0.798 | | |
| J | 0.34 | 1.11 | 2.77 | 0.0146 | 0.0139 | 0.772 | 0.018 | 0.0172 | | | | | | |
| K | 0.36 | 0.58 | 2.38 | 0.0085 | 0.0045 | 0.665 | 0.002 | 0.0011 | | | | | | 0.0035 |
| L | 0.37 | 1.09 | 2.39 | 0.0097 | 0.0063 | 0.266 | 0.001 | 0.0155 | | | | | | |
| M | 0.18 | 1.35 | 1.87 | 0.0187 | 0.0135 | 0.915 | 0.008 | 0.0197 | | 0.410 | | | | |
| N | 0.25 | 0.61 | 1.76 | 0.0018 | 0.0144 | 0.352 | 0.007 | 0.0083 | | | | 0.724 | | |
| O | 0.29 | 1.50 | 3.15 | 0.0046 | 0.0056 | 0.604 | 0.005 | 0.0085 | | | | | | 0.0011 |
| P | 0.32 | 1.90 | 1.97 | 0.0062 | 0.0166 | 0.192 | 0.011 | 0.0030 | | | | 0.429 | | 0.0072 |
| Q | 0.31 | 0.61 | 3.29 | 0.0157 | 0.0168 | 0.925 | 0.013 | 0.0137 | | | | | | |
| R | 0.16 | 0.18 | 1.17 | 0.0075 | 0.0077 | 0.854 | 0.012 | 0.0188 | | | | | | 0.0009 |
| S | 0.19 | 0.97 | 2.59 | 0.0184 | 0.0082 | 0.014 | 0.005 | 0.0050 | | | 0.750 | 1.891 | | |
| T | 0.28 | 0.13 | 1.18 | 0.0092 | 0.0042 | 0.275 | 0.019 | 0.0164 | | | | | 0.465 | |
| U | 0.29 | 0.82 | 3.11 | 0.0010 | 0.0093 | 0.194 | 0.002 | 0.0025 | | | | | | |
| V | 0.23 | 0.90 | 1.60 | 0.0023 | 0.0123 | 0.477 | 0.004 | 0.0119 | 0.2725 | | | | | |
| W | 0.37 | 1.62 | 3.33 | 0.0064 | 0.0076 | 0.154 | 0.017 | 0.0114 | | | 0.661 | | 0.462 | 0.0054 |
| X | 0.12 | 1.41 | 1.80 | 0.0173 | 0.0182 | 0.599 | 0.018 | 0.0133 | | | | | | |
| Y | 0.41 | 0.36 | 2.00 | 0.0035 | 0.0144 | 0.971 | 0.003 | 0.0080 | | | | | | |
| Z | 0.27 | 2.05 | 1.17 | 0.0155 | 0.0058 | 0.621 | 0.002 | 0.0159 | | | | | | |
| AA | 0.37 | 1.66 | 0.55 | 0.0064 | 0.0064 | 0.041 | 0.009 | 0.0147 | | | | | | |
| AB | 0.30 | 0.32 | 3.56 | 0.0176 | 0.0104 | 0.483 | 0.019 | 0.0020 | | | | | | |
| AC | 0.30 | 0.74 | 1.48 | 0.0205 | 0.0161 | 0.601 | 0.013 | 0.0093 | | | | | | |
| AD | 0.29 | 0.36 | 1.41 | 0.0038 | 0.0207 | 0.779 | 0.010 | 0.0042 | | | | | | |
| AE | 0.31 | 0.25 | 2.68 | 0.0012 | 0.0116 | 1.031 | 0.012 | 0.0141 | | | | | | |
| AF | 0.37 | 1.02 | 2.21 | 0.0021 | 0.0165 | 0.651 | 0.021 | 0.0100 | | | | | | |
| AG | 0.24 | 1.10 | 2.44 | 0.0162 | 0.0055 | 0.199 | 0.009 | 0.4050 | | | | | | |
| AH | 0.26 | 0.61 | 2.81 | 0.0141 | 0.0134 | 0.625 | 0.018 | 0.0161 | 0.8960 | | | 1.589 | | |
| AI | 0.21 | 0.85 | 0.98 | 0.0069 | 0.0088 | 0.850 | 0.015 | 0.0175 | | 1.677 | | | | |
| AJ | 0.19 | 1.57 | 2.09 | 0.0051 | 0.0179 | 0.431 | 0.007 | 0.0044 | | | 1.443 | | | 0.0021 |
| AK | 0.27 | 0.04 | 1.05 | 0.0152 | 0.0090 | 0.262 | 0.014 | 0.0171 | | | | 2.554 | | |
| AL | 0.21 | 1.45 | 0.89 | 0.0082 | 0.0162 | 0.124 | 0.002 | 0.0195 | | | | | 0.998 | 0.0014 |
| AM | 0.32 | 0.64 | 1.67 | 0.0052 | 0.0041 | 0.711 | 0.005 | 0.0102 | | | | | | 0.3340 |
| AN | 0.19 | 1.92 | 2.74 | 0.0061 | 0.0052 | 0.773 | 0.010 | 0.0073 | | 0.572 | | | | |
| AO | 0.26 | 1.86 | 2.20 | 0.0018 | 0.0009 | 0.621 | 0.009 | 0.0031 | | | 0.524 | | | |
| AP | 0.32 | 0.95 | 2.46 | 0.0146 | 0.0117 | 0.888 | 0.005 | 0.0113 | | | | | | |
| AQ | 0.36 | 0.91 | 3.03 | 0.0193 | 0.0149 | 0.404 | 0.004 | 0.0183 | | | | | | |
| AR | 0.17 | 1.77 | 2.06 | 0.0022 | 0.0092 | 0.130 | 0.016 | 0.0110 | | | | | | |
| AS | 0.25 | 1.10 | 2.69 | 0.0192 | 0.0157 | 0.944 | 0.008 | 0.0063 | | | | | | |
| AT | 0.21 | 0.15 | 2.30 | 0.0104 | 0.0126 | 0.914 | 0.002 | 0.0130 | 0.0951 | | | | | |

Underlined bold entries indicate outside scope of present invention.

TABLE 1-2

| | Chemical composition (mass %), balance: Fe and impurities | | | | | | | | | | | | | |
|---|---|---|---|---|---|---|---|---|---|---|---|---|---|---|
| No. | Nb | V | Cu | W | Ta | Sn | Sb | As | Mg | Ca | Y | Zr | La | Ce |
| A | | | | | | | | | | | | | | 0.043 |
| B | | 0.466 | | | | | | | | | | | | |
| C | | | | | | | | | | | | | | |
| D | | | 0.473 | | | | | | | | | | | |
| E | | | | | | | | 0.033 | | | | | | |
| F | | | | | | 0.085 | 0.050 | | | | | | | |
| G | | | | | | | | | | | | | | |
| H | | | | | | | | | | | | | | |
| I | | | | | | | | | | | | | | |
| J | | | | | | | | | | | | | | |
| K | 0.440 | | | | | | | | 0.0240 | | | | | |
| L | | | | | | | | | | | | | | |
| M | | | 0.393 | | | | | | | 0.036 | | | | |
| N | | | | | | | | | | | | | | |
| O | | | | | 0.040 | | | | | | | 0.044 | | |
| P | | | | | | | | | | | | | | |
| O | | | | | 0.031 | | | | | | 0.043 | | 0.031 | |
| R | | | | 0.081 | | | | | | | | | | |
| S | | | | | | | | | | | | | | |
| T | | | | | 0.057 | | | | | | | | | |
| U | | | | | | | | | | | | | | |
| V | | | | | | | | | | | | | | |
| W | | | | | | | | | | | | | | |
| X | | | | | | | | | | | | | | |
| Y | | | | | | | | | | | | | | |
| Z | | | | | | | | | | | | | | |
| AA | | | | | | | | | | | | | | |
| AB | | | | | | | | | | | | | | |
| AC | | | | | | | | | | | | | | |
| AD | | | | | | | | | | | | | | |
| AE | | | | | | | | | | | | | | |
| AF | | | | | | | | | | | | | | |
| AG | | | | | | | | | | | | | | |
| AH | | | | | | | | | | | | | | |
| AI | | | 0.440 | | | | | | | | | | | |
| AJ | | | | | | | | | 0.043 | | | | | |
| AK | | | | | | | | | | | | | | |
| AL | | | | | | | | | | | | | | 0.041 |
| AM | 0.259 | | | | | | | | | | | | | |
| AN | | | 0.988 | | | | | | | | | | | |
| AO | | | | 0.491 | | | | | | | | | | |
| AP | | | | | | 0.444 | | | | | | | | |
| AO | | | | | | | 0.765 | | | | | | | |
| AR | | | | | | | | | 0.0334 | 0.789 | | | | |
| AS | | | | | 0.056 | | | | | | 0.132 | | | |
| AT | | | | | | | | | | | | 0.235 | | |

Underlined bold entries indicate outside scope of present invention.

TABLE 2

| | | | | | | Ratio of | | | | | | |
|---|---|---|---|---|---|---|---|---|---|---|---|---|
| | | | | | | macro | Amount of P | | | | | |
| | Martensite | | | | | brittle | segregation of | | | | | |
| | and tempered | | Balance | | | fracture | prior γ grain | | | | Hydrogen | |
| | martensite | Ferrite | structure | | | surface | boundaries | Coating | TS | t-E1 | embrittlement | |
| No. | (area %) | (area %) | (area %) | Hs/Hc | Cs/Cc | (%) | (atm %) | layer | (MPa) | (%) | resistance | Remarks |
| A-1 | 95.2 | 3.0 | 1.8 | 0.84 | 0.72 | 8.8 | 0.97 | GI | 1522 | 8.5 | OK | Inv. ex. |
| B-1 | 96.5 | 1.0 | 2.5 | 0.82 | 0.81 | 32.1 | 2.99 | GI | 1574 | 8.2 | OK | Inv. ex. |
| C-1 | 97.6 | 2.0 | 0.4 | 0.71 | 0.76 | 33.1 | 2.11 | — | 1769 | 7.6 | OK | Inv. ex. |
| D-1 | 97.4 | 2.0 | 0.6 | 0.54 | 0.44 | 24.6 | 3.11 | — | 1928 | 7.0 | OK | Inv. ex. |
| E-1 | 93.9 | 6.0 | 0.1 | 0.88 | 0.74 | 22.1 | 3.09 | GA | 2013 | 7.1 | OK | Inv. ex. |
| F-1 | 95.8 | 4.0 | 0.2 | 0.55 | 0.52 | 18.5 | 2.41 | — | 2095 | 5.8 | OK | Inv. ex. |
| G-1 | 100.0 | 0.0 | 0.0 | 0.86 | 0.67 | 10.2 | 1.87 | GA | 1936 | 6.9 | OK | Inv. ex. |
| H-1 | 100.0 | 0.0 | 0.0 | 0.82 | 0.74 | 15.4 | 2.05 | — | 1769 | 7.4 | OK | Inv. ex. |
| I-1 | 100.0 | 0.0 | 0.0 | 0.58 | 0.49 | 16.5 | 0.69 | — | 2066 | 6.8 | OK | Inv. ex. |
| J-1 | 100.0 | 0.0 | 0.0 | 0.64 | 0.66 | 25.6 | 2.44 | GA | 1938 | 7.7 | OK | Inv. ex. |
| K-1 | 96.8 | 0.0 | 3.2 | 0.78 | 0.71 | 14.8 | 1.64 | — | 2084 | 6.9 | OK | Inv. ex. |
| L-1 | 100.0 | 0.0 | 0.0 | 0.67 | 0.62 | 19.4 | 1.94 | GA | 2068 | 7.3 | OK | Inv. ex. |
| M-1 | 98.2 | 0.0 | 1.8 | 0.83 | 0.60 | 31.5 | 2.97 | GA | 1512 | 8.2 | OK | Inv. ex. |
| N-1 | 94.7 | 3.0 | 2.3 | 0.85 | 0.77 | 16.7 | 0.46 | — | 1747 | 8.9 | OK | Inv. ex. |
| O-1 | 95.6 | 2.0 | 2.4 | 0.91 | 0.76 | 17.7 | 0.87 | — | 1865 | 5.4 | OK | Inv. ex. |
| P-1 | 93.8 | 3.0 | 3.2 | 0.76 | 0.73 | 16.4 | 0.99 | — | 1922 | 4.9 | OK | Inv. ex. |
| Q-1 | 94.8 | 3.0 | 2.2 | 0.71 | 0.82 | 13.4 | 2.32 | GI | 1859 | 8.3 | OK | Inv. ex. |
| R-1 | 97.8 | 2.0 | 0.2 | 0.85 | 0.59 | 2.5 | 0.12 | GA | 1584 | 7.6 | OK | Inv. ex. |
| S-1 | 100.0 | 0.0 | 0.0 | 0.86 | 0.76 | 30.4 | 2.41 | — | 1529 | 9.2 | OK | Inv. ex. |
| T-1 | 95.8 | 2.0 | 2.2 | 0.86 | 0.65 | 24.1 | 1.88 | — | 1822 | 7.8 | OK | Inv. ex. |
| U-1 | 97.8 | 2.0 | 0.2 | 0.87 | 0.81 | 14.6 | 0.39 | GI | 1859 | 7.7 | OK | Inv. ex. |
| V-1 | 96.5 | 2.5 | 1.0 | 0.72 | 0.75 | 13.1 | 0.85 | GA | 1694 | 6.1 | OK | Inv. ex. |
| W-1 | 100.0 | 0.0 | 0.0 | 0.58 | 0.55 | 15.9 | 1.09 | GA | 2022 | 8.0 | OK | Inv. ex. |
| X-1 | 100.0 | 0.0 | 0.0 | 0.79 | 0.64 | 22.8 | 3.22 | — | 1422 | 10.3 | OK | Comp. ex. |
| Y-1 | 100.0 | 0.0 | 0.0 | 0.58 | 0.35 | 4.5 | 0.64 | GA | 1967 | 8.2 | NG | Comp. ex. |
| Z-1 | 98.1 | 1.0 | 0.9 | 0.83 | 0.68 | 15.8 | 1.92 | GI | 1822 | 7.1 | NG | Comp. ex. |
| AA-1 | 86.5 | 12.0 | 1.5 | 0.57 | 0.55 | 9.8 | 0.89 | — | 1428 | 6.4 | OK | Comp. ex. |
| AB-1 | 96.7 | 3.0 | 0.3 | 0.88 | 0.69 | 31.5 | 2.55 | — | 1902 | 7.2 | NG | Comp. ex. |
| AC-1 | 95.8 | 1.0 | 3.2 | 0.88 | 0.82 | 36.7 | 4.58 | GI | 1920 | 6.8 | NG | Comp. ex. |
| AD-1 | 97.1 | 0.0 | 2.9 | 0.79 | 0.75 | 8.9 | 0.89 | GA | 1902 | 6.2 | NG | Comp. ex. |
| AE-1 | 100.0 | 0.0 | 0.0 | 0.64 | 0.63 | 2.8 | 0.22 | GI | 1825 | 7.2 | NG | Comp. ex. |
| AF-1 | 98.0 | 0.0 | 2.0 | 0.74 | 0.44 | 10.50 | 0.89 | GA | 2104 | 6.9 | NG | Comp. ex. |
| AG-1 | 96.0 | 1.0 | 3.0 | 0.70 | 0.45 | 22.80 | 2.67 | — | 1709 | 8.1 | NG | Comp. ex. |
| AH-1 | 98.0 | 2.0 | 0.0 | 0.80 | 0.70 | 26.70 | 2.66 | — | 1728 | 7.6 | NG | Comp. ex. |
| AI-1 | 96.8 | 3.0 | 0.2 | 0.90 | 0.83 | 19.40 | 1.76 | GI | 1644 | 8.3 | NG | Comp. ex. |
| AJ-1 | 96.0 | 4.0 | 0.0 | 0.66 | 0.76 | 14.60 | 2.22 | GA | 1572 | 7.6 | NG | Comp. ex. |
| AK-1 | 99.0 | 1.0 | 0.0 | 0.90 | 0.71 | 27.40 | 3.18 | GA | 1822 | 7.2 | NG | Comp. ex. |
| AL-1 | 98.2 | 0.0 | 1.8 | 0.89 | 0.83 | 15.40 | 0.79 | — | 1633 | 8.1 | NG | Comp. ex. |
| AM-1 | 100.0 | 0.0 | 0.0 | 0.69 | 0.59 | 13.20 | 0.62 | GA | 2009 | 7.2 | NG | Comp. ex. |
| AN-1 | 96.8 | 1.0 | 2.2 | 0.89 | 0.86 | 13.90 | 0.94 | GA | 1572 | 8.3 | NG | Comp. ex. |
| AO-1 | 98.6 | 0.0 | 1.4 | 0.89 | 0.74 | 2.90 | 0.26 | — | 1812 | 7.3 | NG | Comp. ex. |
| AP-1 | 98.7 | 0.0 | 1.3 | 0.86 | 0.58 | 3.50 | 2.38 | — | 1968 | 7.4 | NG | Comp. ex. |
| AQ-1 | 100.0 | 0.0 | 0.0 | 0.80 | 0.82 | 14.10 | 3.41 | GI | 2095 | 7.4 | NG | Comp. ex. |
| AR-1 | 100.0 | 0.0 | 0.0 | 0.77 | 0.72 | 18.90 | 0.85 | GA | 1509 | 8.3 | NG | Comp. ex. |
| AS-1 | 97.8 | 2.0 | 0.2 | 0.92 | 0.68 | 26.40 | 2.41 | — | 1758 | 8.4 | NG | Comp. ex. |
| AT-1 | 99.0 | 1.0 | 0.0 | 0.93 | 0.77 | 17.50 | 1.59 | GA | 1628 | 8.6 | NG | Comp. ex. |

Underlined bold entries indicate outside scope of present invention.

Referring to Tables 1 and 2, in Example X-1, the C content was low, and therefore the TS was less than 1500 MPa. In Example Y-1, the C content was high, and therefore coarse grain boundary carbides were formed and the hydrogen embrittlement resistance of the bent parts fell. In Example Z-1, the Si content was high, and therefore the hydrogen embrittlement resistance of the bent parts fell. In Example AA-1, the Mn content was low, and therefore the hardenability fell, the desired hard structures could not be obtained, and as a result the TS was less than 1500 MPa. In Example AB-1, the Mn content was high, and therefore the hydrogen embrittlement resistance of the bent parts fell. In Example AC-1, the P content was high, and therefore the ratio of macro brittle fracture surface could not be controlled to 35.0% or less and, as a result, the hydrogen embrittlement resistance of the bent parts fell. In Examples AD-1 to AT-1, the TS was good, but the respective S, Al, N, O, Co, Ni, Mo, Cr, Ti, B, Cu, W, Sn, Sb, Ca, Y, and Zr contents were high, and therefore sufficient hydrogen embrittlement resistance of the bent parts could not be achieved.

In contrast to this, in the steel sheets of all of the invention examples, by having a predetermined chemical composition, controlling the Hs/Hc to 0.95 or less and, further, controlling ratio of macro brittle fracture surface in a Charpy impact test to 35.0% or less, despite having extremely high TS of 1500 MPa or more, the hydrogen embrittlement resistance of the bent parts could be remarkably improved.

### Examples B

Next, to investigate the effects of the production conditions, focusing on Steel Types A to W recognized to have excellent characteristics in Table 2, steel sheets having 1.4 mm sheet thickness were produced by the production conditions shown in Table 3. The conditions other than the production conditions shown in Table 3 were the same as the case of Examples A. The properties of the obtained steel sheets were measured and evaluated in the same way as the case of Examples A. The results are shown in Table 4.

TABLE 3

| | Hot rolling step | | | | Cold | Annealing step | | | | | Cooling | |
|---|---|---|---|---|---|---|---|---|---|---|---|---|
| | | Finish | | | rolling | | | | | 400 to | step | |
| | Slab | rolling | Average | | step | Dew | Hydrogen | Max. | | 600° C. | Average | |
| | heating | end | cooling | Coiling | Rolling | point | conc. | heating | Holding | dwell | cooling | Coating |
| | temp. | temp. | speed | temp. | reduction | at ≥700° C. | at ≥700° C. | temp. | time | time | speed | step |
| No. | (° C.) | (° C.) | (° C./s) | (° C.) | (%) | (° C.) | (%) | (° C.) | (s) | (s) | (° C./s) | Plating |
| A-2 | 1233 | 991 | 74 | 478 | 63 | −9.7 | 5.7 | 882 | 36 | 230 | 68 | GA |
| B-2 | 1115 | 1013 | 25 | 311 | 77 | −5.8 | 5.8 | 858 | 56 | 297 | 74 | GI |
| C-2 | 1137 | 917 | 39 | 418 | 68 | 0.0 | 9.4 | 838 | 107 | 47 | 31 | — |
| D-2 | 1111 | 999 | 35 | 347 | 76 | 5.5 | 3.7 | 872 | 74 | 288 | 72 | — |
| E-2 | 1218 | 967 | 72 | 319 | 76 | 7.2 | 1.7 | 884 | 132 | 199 | 81 | — |
| F-2 | 1260 | 874 | 49 | 312 | 56 | −8.5 | 7.9 | 853 | 40 | 48 | 50 | — |
| G-2 | 1119 | 945 | 51 | 412 | 70 | −3.1 | 5.5 | 885 | 30 | 312 | 70 | — |
| H-2 | 1210 | 946 | 37 | 388 | 44 | −12.5 | 3.1 | 880 | 60 | 247 | 85 | — |
| I-2 | 1275 | 1036 | 49 | 373 | 64 | 7.9 | 1.6 | 835 | 97 | ¥54 | 24 | GI |
| J-2 | 1181 | 1001 | 75 | 430 | 62 | −8.3 | 4.2 | 869 | 146 | 108 | 52 | GA |
| K-2 | 1206 | 947 | 29 | 468 | 47 | −18.5 | 2.3 | 894 | 103 | 67 | 43 | GA |
| L-2 | 1290 | 880 | 42 | 361 | 41 | −5.6 | 6.0 | 890 | 49 | 262 | 96 | — |
| M-2 | 1173 | 978 | 77 | 340 | 36 | 2.2 | 8.2 | 856 | 60 | 98 | 58 | — |
| N-2 | 1230 | 985 | 26 | 463 | 72 | −14.1 | 8.4 | 842 | 113 | 294 | 42 | — |
| O-2 | 1269 | 1026 | 44 | 489 | 64 | 5.5 | 8.9 | 868 | 137 | 317 | 44 | — |
| P-2 | 1198 | 965 | 31 | 415 | 51 | −1.6 | 6.8 | 847 | 51 | 143 | 29 | GA |
| Q-2 | 1249 | 861 | 22 | 460 | 49 | −1.5 | 9.0 | 841 | 67 | 139 | 77 | GA |
| R-2 | 1249 | 971 | 66 | 362 | 53 | −12.3 | 5.2 | 874 | 134 | 26 | 69 | GA |
| S-2 | 1123 | 908 | 62 | 401 | 42 | −5.5 | 4.8 | 838 | 124 | 172 | 55 | — |
| T-2 | 1169 | 1037 | 33 | 398 | 57 | 5.6 | 1.8 | 894 | 91 | 86 | 39 | — |
| U-2 | 1154 | 893 | 56 | 488 | 69 | 7.8 | 9.7 | 896 | 103 | 346 | 62 | GI |
| V-2 | 1288 | 1012 | 33 | 463 | 49 | 0.8 | 2.6 | 852 | 82 | 156 | 88 | GI |
| W-2 | 1130 | 871 | 44 | 425 | 37 | −18.6 | 6.3 | 849 | 131 | 126 | 36 | — |
| A-3 | 1192 | 920 | 65 | 349 | 39 | −8.9 | 3.7 | 866 | 41 | 161 | 25 | — |
| B-3 | 1195 | 908 | 60 | 367 | 73 | −5.2 | 2.4 | 876 | 90 | 196 | 31 | GA |
| C-3 | 1277 | 937 | 69 | 438 | 54 | −7.4 | 7.6 | 875 | 114 | 84 | 62 | — |
| D-3 | 1176 | 894 | 68 | 327 | 73 | −10.0 | 3.1 | 887 | 83 | 223 | 88 | — |
| E-3 | 1152 | 1026 | 58 | 333 | 60 | 5.6 | 8.1 | 862 | 23 | 256 | 94 | — |
| F-3 | 1235 | 856 | 53 | 391 | 45 | 2.1 | 4.5 | 837 | 125 | 24 | 48 | GA |
| G-3 | 1149 | 924 | 50 | 453 | 53 | −6.2 | 7.3 | 849 | 71 | 265 | 92 | GA |
| H-3 | 1165 | 942 | 42 | 314 | 45 | −31.5 | 5.5 | 890 | 45 | 134 | 53 | GA |
| I-3 | 1270 | 1039 | 30 | 398 | 43 | 11.2 | 4.3 | 866 | 68 | 221 | 64 | GA |
| J-3 | 1236 | 1019 | 26 | 452 | 49 | 5.5 | 0.5 | 856 | 61 | 302 | 91 | — |
| K-3 | 1190 | 976 | 52 | 408 | 40 | −12.4 | 10.3 | 873 | 71 | 24 | 40 | — |
| L-3 | 1154 | 995 | 37 | 368 | 49 | −8.9 | 9.7 | 827 | 88 | 241 | 32 | GI |
| M-3 | 1263 | 919 | 65 | 408 | 59 | 0.1 | 7.3 | 902 | 114 | 123 | 65 | GI |
| N-3 | 1281 | 965 | 70 | 326 | 75 | −8.3 | 6.0 | 882 | 16 | 345 | 48 | — |
| O-3 | 1131 | 889 | 34 | 491 | 74 | 0.2 | 3.1 | 843 | 155 | 94 | 29 | — |
| P-3 | 1244 | 959 | 37 | 435 | 60 | −9.8 | 4.4 | 852 | 23 | 359 | 85 | GA |
| Q-3 | 1199 | 899 | 40 | 422 | 71 | −5.2 | 8.8 | 833 | 29 | 326 | 18 | GA |

Underlined bold entries indicate outside scope of present invention.

TABLE 4

| | | | | | | Ratio of | Amount of P | | | | |
|---|---|---|---|---|---|---|---|---|---|---|---|
| | | | | | | macro | segregation | | | | |
| | Martensite | | | | | brittle | of prior γ | | | | |
| | and tempered | | Balance | | | fracture | grain | | | Hydrogen | |
| | martensite | Ferrite | structure | | | surface | boundaries | TS | t-E1 | embrittlement | |
| No. | (area %) | (area %) | (area %) | Hs/Hc | Cs/Cc | (%) | (atm %) | (MPa) | (%) | resistance | Remarks |
| A-2 | 93.5 | 4.2 | 2.3 | 0.88 | 0.76 | 11.5 | 1.55 | 1547 | 8.2 | OK | Inv. ex. |
| B-2 | 100.0 | 0.0 | 0.0 | 0.86 | 0.83 | 33.8 | 3.24 | 1532 | 8.1 | OK | Inv. ex. |
| C-2 | 100.0 | 0.0 | 0.0 | 0.79 | 0.79 | 25.7 | 1.88 | 1722 | 7.9 | OK | Inv. ex. |
| D-2 | 98.0 | 2.0 | 0.0 | 0.51 | 0.48 | 31.6 | 3.33 | 1869 | 6.8 | OK | Inv. ex. |
| E-2 | 95.5 | 2.5 | 2.0 | 0.82 | 0.69 | 30.7 | 3.41 | 1997 | 7.2 | OK | Inv. ex. |
| F-2 | 94.0 | 3.5 | 2.5 | 0.75 | 0.75 | 15.4 | 2.31 | 2011 | 6.9 | OK | Inv. ex. |
| G-2 | 94.6 | 2.6 | 2.8 | 0.88 | 0.71 | 11.8 | 1.55 | 1865 | 7.8 | OK | Inv. ex. |
| H-2 | 100.0 | 0.0 | 0.0 | 0.80 | 0.71 | 20.9 | 2.31 | 1759 | 8.1 | OK | Inv. ex. |
| I-2 | 97.0 | 3.0 | 0.0 | 0.52 | 0.47 | 11.7 | 0.55 | 1975 | 6.9 | OK | Inv. ex. |
| J-2 | 100.0 | 0.0 | 0.0 | 0.62 | 0.64 | 26.8 | 2.22 | 1926 | 7.2 | OK | Inv. ex. |
| K-2 | 98.0 | 1.2 | 0.8 | 0.81 | 0.71 | 12.6 | 1.33 | 2059 | 6.7 | OK | Inv. ex. |
| L-2 | 96.3 | 2.1 | 1.6 | 0.61 | 0.57 | 25.8 | 2.04 | 2018 | 7.6 | OK | Inv. ex. |
| M-2 | 95.8 | 3.2 | 1.0 | 0.85 | 0.67 | 21.9 | 1.79 | 1529 | 8.3 | OK | Inv. ex. |
| N-2 | 97.0 | 3.0 | 0.0 | 0.81 | 0.71 | 21.5 | 0.94 | 1734 | 7.4 | OK | Inv. ex. |
| O-2 | 94.8 | 2.8 | 2.4 | 0.73 | 0.67 | 21.1 | 1.36 | 1822 | 6.3 | OK | Inv. ex. |
| P-2 | 98.0 | 2.0 | 0.0 | 0.77 | 0.73 | 5.8 | 0.84 | 1921 | 5.1 | OK | Inv. ex. |
| Q-2 | 96.2 | 1.8 | 2.0 | 0.64 | 0.80 | 16.9 | 2.19 | 1854 | 7.3 | OK | Inv. ex. |
| R-2 | 100.0 | 0.0 | 0.0 | 0.80 | 0.55 | 6.9 | 0.39 | 1583 | 7.3 | OK | Inv. ex. |
| S-2 | 97.5 | 2.5 | 0.0 | 0.88 | 0.78 | 26.7 | 2.37 | 1555 | 8.3 | OK | Inv. ex. |
| T-2 | 100.0 | 0.0 | 0.0 | 0.59 | 0.48 | 17.6 | 1.94 | 1758 | 7.2 | OK | Inv. ex. |
| U-2 | 97.0 | 1.2 | 1.8 | 0.79 | 0.76 | 19.5 | 0.85 | 1866 | 7.7 | OK | Inv. ex. |
| V-2 | 95.0 | 0.0 | 5.0 | 0.74 | 0.77 | 13.9 | 0.67 | 1702 | 6.8 | OK | Inv. ex. |
| W-2 | 98.0 | 0.0 | 2.0 | 0.67 | 0.61 | 18.9 | 1.01 | 1939 | 7.4 | OK | Inv. ex. |
| A-3 | 96.4 | 2.7 | 0.9 | 0.85 | 0.76 | 17.4 | 1.44 | 1537 | 6.3 | OK | Inv. ex. |
| B-3 | 97.8 | 1.8 | 0.4 | 0.45 | 0.44 | 24.9 | 3.12 | 1596 | 8.6 | OK | Inv. ex. |
| C-3 | 94.9 | 3.1 | 2.0 | 0.64 | 0.64 | 27.6 | 1.84 | 1749 | 7.6 | OK | Inv. ex. |
| D-3 | 96.7 | 2.2 | 1.1 | 0.51 | 0.49 | 24.5 | 2.49 | 1868 | 6.6 | OK | Inv. ex. |
| E-3 | 93.8 | 2.9 | 3.3 | 0.72 | 0.67 | 19.4 | 2.48 | 1976 | 7.6 | OK | Inv. ex. |
| F-3 | 93.4 | 3.1 | 3.5 | 0.81 | 0.81 | 14.7 | 1.49 | 2054 | 8.0 | OK | Inv. ex. |
| G-3 | 99.0 | 1.0 | 0.0 | 0.86 | 0.75 | 16.4 | 2.22 | 1952 | 6.7 | OK | Inv. ex. |
| H-3 | 96.4 | 1.2 | 2.4 | 0.98 | 0.97 | 2.8 | 1.49 | 1788 | 6.1 | NG | Comp. ex. |
| I-3 | 98.1 | 1.9 | 0.0 | 0.47 | 0.35 | 16.7 | 0.88 | 1967 | 7.4 | OK | Inv. ex. |
| J-3 | 97.2 | 2.8 | 0.0 | 0.19 | 0.27 | 30.5 | 2.67 | 1468 | 8.4 | OK | Comp. ex. |
| K-3 | 98.2 | 1.0 | 0.8 | 0.96 | 0.96 | 16.9 | 1.41 | 2066 | 7.2 | NG | Comp. ex. |
| L-3 | 75.8 | 15.9 | 8.3 | 0.82 | 0.75 | 22.6 | 1.79 | 1465 | 7.6 | OK | Comp. ex. |
| M-3 | 98.2 | 1.8 | 0.0 | 0.85 | 0.62 | 38.2 | 3.69 | 1564 | 8.6 | NG | Comp. ex. |
| N-3 | 85.2 | 8.7 | 6.1 | 0.86 | 0.78 | 14.2 | 0.88 | 1396 | 4.9 | OK | Comp. ex. |
| O-3 | 96.8 | 3.2 | 0.0 | 0.73 | 0.72 | 36.7 | 3.99 | 1765 | 8.3 | NG | Comp. ex. |
| P-3 | 98.6 | 1.4 | 0.0 | 0.74 | 0.74 | 41.1 | 3.84 | 1858 | 5.9 | NG | Comp. ex. |
| Q-3 | 76.1 | 2.5 | 21.4 | 0.76 | 0.85 | 15.2 | 3.05 | 1465 | 4.1 | OK | Comp. ex. |

Underlined bold entries indicate outside scope of present invention.

Referring to Tables 3 and 4, in Example H-3, the dew point of the annealing step was low, and therefore decarburization of the surface layer parts could not be made to sufficiently proceed and the desired surface layer softening, i.e., Hs/Hc≤0.95, could not be achieved. As a result, the hydrogen embrittlement resistance of the bent parts fell. In Example J-3 [symbol] , the hydrogen concentration in the annealing step was low, and therefore the decarburization of the surface layer parts ended up proceeding too much and TS of 1500 MPa or more could not be achieved. In Example K-3, the hydrogen concentration in the annealing step was high, and therefore decarburization of the surface layer parts could not be made to sufficiently proceed and Hs/Hc≤0.95 could not be achieved. As a result, the hydrogen embrittlement resistance of the bent parts fell. In Example L-3, the maximum heating temperature of the annealing step was low, and therefore the austenizing became insufficient and the desired hard structures could not be obtained in the finally obtained steel sheet. As a result, TS of 1500 MPa or more could not be achieved. In Example M-3, the maximum heating temperature of the annealing step was high, and therefore in the final microstructure, the martensite coarsened and along with that the grain boundary area fell whereupon, it is believed, the amount of segregation of P at the prior austenite grain boundaries increased relatively. As a result, the ratio of macro brittle fracture surface could not be controlled to 35.0% or less and the hydrogen embrittlement resistance of the bent parts fell. In Example N-3, the holding time at the maximum heating temperature in the annealing step was short, and therefore the austenizing became insufficient and the desired hard structures could not be obtained in the finally obtained steel sheet. As a result, TS of 1500 MPa or more could not be achieved. In Example O-3, the holding time at the maximum heating temperature in the annealing step was long, and therefore segregation of P at the grain boundaries ended up increasing. As a result, the ratio of macro brittle fracture surface could not be controlled to 35.0% or less and the hydrogen embrittlement resistance of the bent parts fell. In Example P-3, the dwell time at the 400 to 600° C. in the annealing step was long, and therefore segregation of P at the grain boundaries ended up increasing. As a result, the ratio of macro brittle fracture surface could not be controlled to 35.0% or less and the hydrogen embrittlement resistance of the bent parts fell. In Example Q-3, the average cooling speed in the cooling step was low, and therefore the desired hard structures could not be obtained in the finally obtained steel sheet. As a result, TS of 1500 MPa or more could not be achieved. As clear from these comparative examples, if just one of “Hs/Hc≤0.95” and “ratio of macro brittle fracture surface: 35.0% or less” is satisfied, sufficient hydrogen embrittlement resistance of the bent parts could not be achieved.

In contrast to this, in all of the invention examples according to the present invention, by using a slab having a predetermined chemical composition, in particular suitably controlling a dew point of an annealing step, hydrogen concentration, maximum heating temperature and holding time at that temperature, dwell time at a temperature region of 400 to 600° C., and average cooling speed of a cooling step, it was possible to produce the steel sheet simultaneously satisfying the requirements of “Hs/Hc≤0.95” and “ratio of macro brittle fracture surface: 35.0% or less. As a result, despite having an extremely high tensile strength of 1500 MPa or more, it was possible to remarkably improve the hydrogen embrittlement resistance of bent parts. Example I-3 had a high dew point of the annealing step, but the original C content was relatively high, and therefore the surface layer parts were not excessively decarburized in state and TS of 1500 MPa or more could be achieved in the finally obtained steel sheet.

1-6. (canceled)

7. A steel sheet having a chemical composition comprising, by mass %,
C: 0.15 to 0.40%,
Si: 0.01 to 2.00%,
Mn: 0.80 to 3.50%,
P: 0.0001 to 0.0200%,
S: 0.0001 to 0.0200%,
Al: 0.001 to 1.000%,
N: 0.0001 to 0.020%,
O: 0.0001 to 0.0200%,
Co: 0 to 0.5000%,
Ni: 0 to 1.000%,
Mo: 0 to 1.000%,
Cr: 0 to 2.000%,
Ti: 0 to 0.500%,
B: 0 to 0.0100%,
Nb: 0 to 0.500%,
V: 0 to 0.500%,
Cu: 0 to 0.500%,
W: 0 to 0.100%,
Ta: 0 to 0.100%,
Sn: 0 to 0.100%,
Sb: 0 to 0.100%,
As: 0 to 0.100%,
Mg: 0 to 0.0500%,
Ca: 0 to 0.050%,
Y: 0 to 0.050%,
Zr: 0 to 0.050%,
La: 0 to 0.050%,
Ce: 0 to 0.050%, and
balance: Fe and impurities, wherein
an average Vickers hardness Hs in a region from at least one surface down to 10% of sheet thickness is 0.95 time or less an average Vickers hardness Hc at a ½ position of sheet thickness,
a ratio of macro brittle fracture surface in a Charpy impact test at room temperature is 35.0% or less, and
a tensile strength is 1500 MPa or more.

8. The steel sheet according to claim 7, wherein the chemical composition includes by mass %, one or more of:
Co: 0.0100 to 0.5000%,
Ni: 0.010 to 1.000%,
Mo: 0.010 to 1.000%,
Cr: 0.001 to 2.000%,
Ti: 0.001 to 0.500%,
B: 0.0001 to 0.0100%,
Nb: 0.001 to 0.500%,
V: 0.001 to 0.500%,
Cu: 0.001 to 0.500%,
W: 0.001 to 0.100%,
Ta: 0.001 to 0.100%,
Sn: 0.001 to 0.100%,
Sb: 0.001 to 0.100%,
As: 0.001 to 0.100%,
Mg: 0.0001 to 0.0500%,
Ca: 0.001 to 0.050%,
Y: 0.001 to 0.050%,
Zr: 0.001 to 0.050%,
La: 0.001 to 0.050%, and
Ce: 0.001 to 0.050%.

9. The steel sheet according to claim 7, having a microstructure at a ½ position of sheet thickness comprising, by area ratio,
martensite and tempered martensite: more than 93.0% in total, and
ferrite: less than 7.0%.

10. The steel sheet according to claim 8, having a microstructure at a ½ position of sheet thickness comprising, by area ratio,
martensite and tempered martensite: more than 93.0% in total, and
ferrite: less than 7.0%.

11. The steel sheet according to claim 7, wherein an average carbon concentration Cs at a region from at least one surface to 10% of sheet thickness is 0.10 to 0.90 time an average carbon concentration Cc of a parent material.

12. The steel sheet according to claim 8, wherein an average carbon concentration Cs at a region from at least one surface to 10% of sheet thickness is 0.10 to 0.90 time an average carbon concentration Cc of a parent material.

13. The steel sheet according to claim 9, wherein an average carbon concentration Cs at a region from at least one surface to 10% of sheet thickness is 0.10 to 0.90 time an average carbon concentration Cc of a parent material.

14. The steel sheet according to claim 10, wherein an average carbon concentration Cs at a region from at least one surface to 10% of sheet thickness is 0.10 to 0.90 time an average carbon concentration Cc of a parent material.

15. The steel sheet according to claim 7, wherein an amount of segregation of P at prior austenite grain boundaries from a ⅛ position of sheet thickness to a ½ position of sheet thickness is 3.50 atm % or less.

16. The steel sheet according to claim 8, wherein an amount of segregation of P at prior austenite grain boundaries from a ⅛ position of sheet thickness to a ½ position of sheet thickness is 3.50 atm % or less.

17. The steel sheet according to claim 9, wherein an amount of segregation of P at prior austenite grain boundaries from a ⅛ position of sheet thickness to a ½ position of sheet thickness is 3.50 atm % or less.

18. The steel sheet according to claim 10, wherein an amount of segregation of P at prior austenite grain boundaries from a ⅛ position of sheet thickness to a ½ position of sheet thickness is 3.50 atm % or less.

19. The steel sheet according to claim 11, wherein an amount of segregation of P at prior austenite grain boundaries from a ⅛ position of sheet thickness to a ½ position of sheet thickness is 3.50 atm % or less.

20. The steel sheet according to claim 12, wherein an amount of segregation of P at prior austenite grain boundaries from a ⅛ position of sheet thickness to a ½ position of sheet thickness is 3.50 atm % or less.

21. The steel sheet according to claim 13, wherein an amount of segregation of P at prior austenite grain boundaries from a ⅛ position of sheet thickness to a ½ position of sheet thickness is 3.50 atm % or less.

22. The steel sheet according to claim 14, wherein an amount of segregation of P at prior austenite grain boundaries from a ⅛ position of sheet thickness to a ½ position of sheet thickness is 3.50 atm % or less.

23. The steel sheet according to claim 7, further including a coated layer containing at least one of zinc, aluminum, magnesium, and alloys thereof on at least one surface.

24. The steel sheet according to claim 8, further including a coated layer containing at least one of zinc, aluminum, magnesium, and alloys thereof on at least one surface.

25. The steel sheet according to claim 9, further including a coated layer containing at least one of zinc, aluminum, magnesium, and alloys thereof on at least one surface.

26. The steel sheet according to claim 10, further including a coated layer containing at least one of zinc, aluminum, magnesium, and alloys thereof on at least one surface.
